SEQUENCE LISTING (28 sequences)

SEQ ID NO: 1 - protein, 12 aa, synthetic construct
KKHRKHRKHRKH

SEQ ID NO: 2 - protein, 13 aa, synthetic construct
MNLSSLSSLLDVR

SEQ ID NO: 3 - protein, 17 aa, synthetic construct
MGINGFKFLSDIHHFCS

SEQ ID NO: 4 - protein, 13 aa, synthetic construct
MRIMIDSLSFDSL

SEQ ID NO: 5 - protein, 17 aa, synthetic construct
MSKISVNEFGLFGKVVV

SEQ ID NO: 6 - protein, 21 aa, synthetic construct
MSNYGVCHYHSCRSNFSQNSV

SEQ ID NO: 7 - protein, 19 aa, synthetic construct
MGKSVYIDFVVMDLIISRS

SEQ ID NO: 8 - protein, 12 aa, synthetic construct
MVGFEDYVNVMW

SEQ ID NO: 9 - protein, 31 aa, synthetic construct
MDFIRYCYDRFCCDLGMSVTLGNTYRGAGGG

SEQ ID NO: 10 - protein, 20 aa, synthetic construct
MGLLGLCDLIFYVYNVYWVE

SEQ ID NO: 11 - protein, 20 aa, synthetic construct
MGLLGLCDLIFYGYNVYWVE

SEQ ID NO: 12 - protein, 17 aa, synthetic construct
QSFYYVSQKKKWFPVKF

SEQ ID NO: 13 - protein, 15 aa, synthetic construct
DLHPQFQNLLKKSQN

SEQ ID NO: 14 - protein, 25 aa, synthetic construct
SRNSSIALGLRRAYAVFNYFVARGI

SEQ ID NO: 15 - protein, 6 aa, synthetic construct
FYVTHW

SEQ ID NO: 16 - protein, 9 aa, synthetic construct
FGGSVGGSH

SEQ ID NO: 17 - protein, 9 aa, synthetic construct
FGSGVGSGH

SEQ ID NO: 18 - protein, 6 aa, synthetic construct
WHVTFY

SEQ ID NO: 19 - protein, 6 aa, synthetic construct
WHVTYF

SEQ ID NO: 20 - protein, 9 aa, synthetic construct
HGGSVGGSF

SEQ ID NO: 21 - protein, 71 aa, synthetic construct
MGINGFKFLSDIHHFCSGGSGGSRICESASYRFKGICVSRSNCANVCKNEGFPGGRCRGFRRRCLCYKHCG

SEQ ID NO: 22 - protein, 71 aa, synthetic construct
RICESASYRFKGICVSRSNCANVCKNEGFPGGRCRGFRRRCLCYKHCGGGSGGSMGINGFKFLSDIHHFCS

SEQ ID NO: 23 - protein, 79 aa, synthetic construct
SRNSSIALGLRRAYAVFNYFVARGIGGSGGSRICESASYRFKGICVSRSNCANVCKNEGFPGGRCRGFRRRCLCYKHCG

SEQ ID NO: 24 - protein, 79 aa, synthetic construct
RICESASYRFKGICVSRSNCANVCKNEGFPGGRCRGFRRRCLCYKHCGGGSGGSSRNSSIALGLRRAYAVFNYFVARGI

SEQ ID NO: 25 - protein, 75 aa, synthetic construct
MGINGFKFLSDIHHFCSGGSGGSGIFSSRKCKTPSKTFKGICTRDSNCDTSCRYEGYPAGDCKGIRRRCLCCTHT

SEQ ID NO: 26 - protein, 75 aa, synthetic construct
GIFSSRKCKTPSKTFKGICTRDSNCDTSCRYEGYPAGDCKGIRRRCLCCTHTGGSGGSMGINGFKFLSDIHHFCS

SEQ ID NO: 27 - protein, 83 aa, synthetic construct
SRNSSIALGLRRAYAVFNYFVARGIGGSGGSGIFSSRKCKTPSKTFKGICTRDSNCDTSCRYEGYPAGDCKGIRRRCLCCTHT

SEQ ID NO: 28 - protein, 83 aa, synthetic construct
GIFSSRKCKTPSKTFKGICTRDSNCDTSCRYEGYPAGDCKGIRRRCLCCTHTGGSGGSSRNSSIALGLRRAYAVFNYFVARGI

(19) United States
(12) Patent Application Publication
(10) Pub. No.: US 2024/0349733 A1
(43) Pub. Date: Oct. 24, 2024

(54) DEVELOPMENT OF SPECIFICALLY TARGETED BINDERS AND ANTIMICROBIAL PEPTIDES (STAMPs) TO CONTROL CANDIDATUS LIBERIBACTER SPP.

(71) Applicants: THE TEXAS A&M UNIVERSITY SYSTEM, COLLEGE STATION, TX (US); UNIVERSITY OF CALIFORNIA RIVERSIDE, RIVERSIDE, CA (US)

(72) Inventors: KRANTHI MANDADI, COLLEGE STATION, TX (US); JAMES BORNEMAN, RIVERSIDE, CA (US); SANDUN FERNANDO, COLLEGE STATION, TX (US); SONIA IRIGOYEN, COLLEGE STATION, TX (US); CARMEN S. PADILLA, COLLEGE STATION, TX (US); MANIKANDAN RAMASAMY, COLLEGE STATION, TX (US); SAMAVATH MALLAWARACHCHI, COLLEGE STATION, TX (US)

(21) Appl. No.: 18/644,446

(22) Filed: Apr. 24, 2024

Related U.S. Application Data
(60) Provisional application No. 63/497,753, filed on Apr. 24, 2023.

(51) Int. Cl. A01N 63/50

(52) U.S. Cl. CPC A01N 63/50

(57) ABSTRACT

The subject invention pertains to controlling and/or treating infections of Candidatus Liberibacter spp. that leads to citrus greening in citrus plants, such as orange trees, grapefruit trees, lime trees, lemon trees and the like and potato zebra chip disease in potato and other tuber plants using specifically targeted antimicrobial peptides (STAMPs).

### CROSS-REFERENCE TO RELATED APPLICATION

This application claims the benefit of U.S. Provisional Application Ser. No. 63/497,753, filed Apr. 24, 2023, the disclosure of which is hereby incorporated by reference in its entirety, including all figures, tables and amino acid or nucleic acid sequences.

### STATEMENT REGARDING FEDERALLY SPONSORED RESEARCH

This invention was made with government support under 2019-70016-29066 awarded by USDA NIFA. The government has certain rights in the invention.

### STATEMENT REGARDING SEQUENCE LISTING

The Sequence Listing for this application is labeled “Seq-List.xml” which was created on Apr. 19, 2024 and is 25,879 bytes. The entire content of the sequence listing is incorporated herein by reference in its entirety.

### BACKGROUND OF THE INVENTION

Fastidious (unculturable) plant pathogens, such as the vascular-limited Candidatus Liberibacter spp., the presumptive causal agents of Huanglongbing (HLB or citrus greening), and potato zebra chip disease, are devastating to agriculture. Due to their recalcitrance to conventional laboratory culturing techniques, specialized lifestyles, and colonization limited to the plant vasculature, it is challenging to deploy therapies that can effectively control these pathogens. Candidatus Liberibacter asiaticus (CLas) is the most devastating disease of citrus today; however, additional related bacteria can also cause the disease, including, for example, Candidatus Liberibacter africanus and Candidatus Liberibacter americanus have been discovered as causative agents for this disease [13]. The bacteria are transmitted by an insect vector, the Asian citrus psyllid (Diaphorina citri) and African citrus psyllid (Trioza erytreae) [13], which transmit the bacteria to the phloem cells during feeding [14]. The bacteria secrete Sec-dependent effectors to the phloem, causing death, necrosis and malfunctioning of phloem

cells [15]. HLB symptoms include yellow leaves, stunted trees and misshapen, green fruit [13, 10].

Since its discovery in 2005 in Florida alone, HLB caused a >60% reduction in citrus acreage and economic losses of up to US $8 billion [1]. Texas, the third largest citrus-producing state behind Florida and California, is currently facing HLB spread, with its unique circumstances of heavily interspersed residential and commercial citrus acreage. HLB was also reported in Louisiana and is spreading in California, the latter state leading in US citrus production. A recent consensus study by the US National Academy of Sciences on citrus greening research and development concluded that no single effective therapy exists to fight the disease [2]. There is an urgent need to develop and deploy a combination of therapies and management practices to control HLB and other devastating diseases caused by Candidatus Liberibacter spp. [2, 3, 4, 5, 6].

Currently there is no cure for HLB, and no HLB-resistant citrus varieties are commercially available [10]. Current methods for managing HLB include controlling psyllid vectors using insecticides, removal of infected trees, and application of antibiotics [10, 16]. These techniques have limited efficacy in controlling the disease, and the high costs involved with these methods make them financially undesirable. Excessive use of antibiotics can also lead to antibiotic resistance in the long term and inhibition of beneficial bacteria [16]. Novel HLB management techniques such as inducing RNA mutations in psyllid vectors and the development of HLB-resistant citrus trees via overexpression of specific genes [18-20] have been reported. However, those techniques are still in the development stage, making it crucial to find an effective treatment for HLB.

A key challenge in developing new therapeutics against HLB is the fastidious (unculturable) and phloem-limited nature of CLas [7, 8]. This limits the application of conventional bacterial culturing, genetics, and biochemical approaches to study CLas and evaluate the efficacy of candidate antimicrobials. Another challenge is that the host plant, citrus, is a perennial tree that is hard to deliver potential therapies into the phloem. As such, efficacy testing against CLas in citrus trees is a laborious and time-consuming process and not practical for pre-screening several candidates. Therefore, the remains a need for compositions and methods of controlling Candidatus Liberibacter spp. in infections in plants.

### BRIEF SUMMARY OF THE INVENTION

This invention relates to peptides and compositions comprising said peptides for the control of C. Liberibacter spp. infections and/or for the treatment of diseases caused by C. Liberibacter spp. infections, including, for example, citrus greening and potato zebra chip disease. In certain embodiments, plants are treated with the disclosed compositions after a disease or infection has been identified within the plant or a grove or other agricultural site, thereby mitigating or reducing the severity of disease in the plants or trees. The subject invention also provides compositions and formulations comprising one or more of the disclosed compounds that are suitable for application to plants/trees exhibiting signs of diseases caused by C. Liberibacter spp.

In certain embodiments, the subject invention comprises multiple specifically targeted peptides that can inhibit Candidatus Liberibacter spp. and related bacteria. The subject invention further comprises targeting peptide binders, including, for example, individual or combinations, linked to various specifically targeted antimicrobial peptides (STAMPs) or the binders alone, which can be used to control diseases caused by C. Liberibacter spp. and can be used as preventative or curative therapies.

In certain embodiments, the subject invention further comprises enhancing the affinity of antimicrobial peptides (AMPs) towards target proteins by fusing the AMPs with high-affinity short peptides (HASPs) that are specific to BamA or other bacterial proteins.

### BRIEF DESCRIPTION OF THE DRAWINGS

The patent or application file contains at least one drawing executed in color. Copies of this patent or patent application publication, with color drawing(s), will be provided by the Office upon request and payment of the necessary fec.

FIGS. 1A-1B. Binding of 22602 and 57020 peptides to CLas and surrogates (Liberibacter crescens, Rhizobium galegae and Rhizobium grahamii). Peptide binders 22602 (FIG. 1A) and 57020 (FIG. 1B) were synthesized with FITC labeling. Binding assays were performed using the bacterial cells/extracts and binders (16 μM). DNA DAPI staining was used to identify all cells in a field of view, while FITC fluorescence indicates cells bound by the binders. The two binders bound to putative CLas cells in bacterial extracts from HLB-affected trees, as well as CLas surrogates (L. crescens, R. galegae and R. grahamii) but not to E. coli or to cells in healthy citrus tree extracts. E. coli (FIG. 1A, Row A; FIG. 1B, Row G). Bacterial extracts from healthy (FIG. 1A, Row B; FIG. 1B, Row H) or CLas-infected citrus trees (FIG. 1A, Row C; FIG. 1A, Row I). Surrogates L. crescens (FIG. 1A, Row D; FIG. 1B, Row J), R. galegae (FIG. 1A, Row E; FIG. 1B, Row K) and R. grahamii (FIG. 1A, Row F; FIG. 1B, Row L). Scale bar=10 μm.

FIGS. 2A-2B. Effect of antimicrobial peptides on L. crescens viability and mortality. Mortality of L. crescens treated with multiple dosages (5, 10, 25, 50, 100 μg/ml) of SoD12, 22602, 57020 binders, and their corresponding STAMPs. Untreated cells and boil treatment were used as controls. Percent (%) mortality was estimated by counting the number of dead cells using a cell viability/mortality staining assay kit (Biotium, Fremont, CA). Error bars represent the ±standard error of the mean (n=3). Asterisks (*) represent treatments that were significantly different (p≤0.01) compared to SoD12 alone at its equivalent dosage.

FIGS. 3A-3B. Effect of antimicrobial peptides on R. galegae viability and mortality. Mortality of R. galegae treated with multiple dosages (50 and 100 μg/ml) of SoD12, 22602, 57020 binders, and their corresponding STAMPs. Untreated cells and boil treatment were used as controls. Percent (%) mortality was estimated by counting the number of dead cells using a cell viability/mortality staining assay kit (Biotium, Fremont, CA). Error bars represent the ±standard error of the mean (n=3). Asterisks (*) represent treatments that were significantly different (p≤0.01) compared to SoD12 alone at its equivalent dosage.

FIGS. 4A-4D. Temporal growth curves of R. grahamii treated with 57020 binder and corresponding STAMPs. R. grahamii cells were cultured in the presence of SoD12, 57020 or 57020-SoD12, SoD12-57020 STAMPs at (FIG. 4A) 10 μg/ml, (FIG. 4B) 25 μM, (FIG. 4C) 50 μM, (FIG. 4D) 100 μM. Cell density measurements were recorded over time till untreated cells (cells) reached OD600 of ˜1. Kanamycin (100 μg/ml) was used as an antibiotic reference inhibitor. Asterisks (*) represent treatments that were significantly different (p≤0.05) compared to untreated or solvent-alone controls. Error bars represent ±standard deviation of the mean (n=3). The peptide dosages shown are in ‘μg/ml’.

FIGS. 5A-5D. Temporal growth curves of R. grahamii treated with 22602 binder and corresponding STAMPs. R. grahamii cells were cultured in the presence of SoD12, 22602 or 22602-SoD12, SoD12-22602 STAMPs at (FIG. 5A) 10 μg/ml, (FIG. 5B) 25 μM, (FIG. 5C) 50 μM, (FIG. 5D) 100 μM. Cell density measurements were recorded over time till untreated cells (cells) reached OD600 of ˜1. Kanamycin (100 μg/ml) was used as an antibiotic reference inhibitor. Asterisks (*) represent treatments that were significantly different (p≤0.05) compared to untreated or solvent-alone controls. Error bars represent ±standard deviation of the mean (n=3). The peptide dosages shown are in ‘μg/ml’.

FIGS. 6A-6B. Efficacy of binders and STAMPs on CLas in vitro using citrus hairy root assay. (FIGS. 6A-6B) CLas-citrus hairy roots were treated with binders (22602, 57020), SoD12, and STAMPs (22602-SoD12, SoD12-22602), SoD12-57020, 57020-SoD12) for ˜72 h at the indicated dosages (μg/ml). Relative CLas titers were estimated using quantitative (q) PCR. Untreated, acetonitrile solvent (0.1, 0.6, or 1.2%) and GFP (100 μg/ml) were used as negative controls, while cinoxacin (50 μM) was used as a reference antibiotic inhibitor. Asterisks (*) represent treatments that were significantly different (p≤0.05) compared to untreated or solvent-alone controls. Error bars represent the ±standard error of the mean (n=3). The peptide dosages shown are in ‘μg/ml’. Additional data is also provided in FIGS. 26A-B and discussed in Example 7.

FIG. 7. Effect of 22602 binder and STAMPs (5 and 10 μg/ml) on L. crescens viability and mortality. Mortality of L. crescens treated with 5 or 10 μg/ml of SoD12, 22602 binder, and STAMPs. Untreated cells and boil treatment were used as controls. Percent (%) mortality was estimated by counting the number of dead cells (red stained) among all cells (green stained). Scale bar=10 μm.

FIG. 8. Effect of 22602 binder and STAMPs (25 and 50 μg/ml) on L. crescens viability and mortality. Mortality of L. crescens treated with 25 or 50 μg/ml of SoD12, 22602 binder, and STAMPs. Untreated cells and boil treatment were used as controls. Percent (%) mortality was estimated by counting the number of dead cells (red stained) among all cells (green stained). Scale bar=10 μm.

FIG. 9. Effect of 22602 binder and STAMPs (100 μg/ml) on L. crescens viability and mortality. Mortality of L. crescens treated with 100 μg/ml of SoD12, 22602 binder, and STAMPs. Untreated cells and boil treatment were used as controls. Percent (%) mortality was estimated by counting the number of dead cells (red stained) among all cells (green stained). Scale bar=10 μm.

FIG. 10. Effect of 57020 binder and STAMPs (5 and 10 μg/ml) on L. crescens viability and mortality. Mortality of L. crescens treated with 5 or 10 μg/ml of SoD12, 57020 binder, and STAMPs. Controls used were cells with no peptide or STAMP and Cells boiled for 10 min. Percent (%) mortality was estimated by counting the number of dead cells (red stained) among all cells (green stained). Scale bar=10 μm.

FIG. 11. Effect of 57020 binder and STAMPs (25 and 50 μg/ml) on L. crescens viability and mortality. Mortality of L. crescens treated with 25 or 50 μg/ml of SoD12, 57020 binder, and STAMPs. Percent (%) mortality was estimated by counting the number of dead cells (red stained) among all cells (green stained). Scale bar=10 μm.

FIG. 12. Effect of 57020 binder and STAMPs (100 μg/ml) on L. crescens viability and mortality. Mortality of L. crescens treated with 100 μg/ml of SoD12, 57020 binder, and STAMPs. Percent (%) mortality was estimated by counting the number of dead cells (red stained) among all cells (green stained). Scale bar=10 μm.

FIG. 13. Effect of 22602 binder and STAMPs (50 and 100 μg/ml) on R. galegae viability and mortality. Mortality of R. galegae treated with 50 or 100 μg/ml of SoD12, 22602 binder, and corresponding STAMPs. Untreated cells and boil treatment were used as controls. Percent (%) mortality was estimated by counting the number of dead cells (red stained) among all cells (green stained). Scale bar=10 μm.

FIG. 14. Effect of 57020 binders and STAMPs (50 and 100 μg/ml) on R. galegae viability and mortality. Mortality of R. galegae treated with 50 or 100 μg/ml of SoD12,57020 binder and STAMPs. Untreated cells and boil treatment were used as controls. Percent (%) mortality was estimated by counting the number of dead cells (red stained) among all cells (green stained). Scale bar=10 μm.

FIGS. 15A-15B. Effects of 22602-SOD12 and SOD12-22602 STAMPs with longer linker sequences on R. grahamii. (FIG. 15A) N-terminal 22602-SOD12 STAMP with 2× or 3× linkers, compared to STAMP with 1× linker (22602-SOD12) FIG. 15B) C-terminal SOD12-22602 STAMP with 2× and 3× linkers, compared to STAMP with 1× linker (SOD12-22602). Error bars represent the ±standard error of the mean (n=3). The peptide dosages shown are in ‘μg/ml’.

FIG. 16. Efficacy of 57020-SOD12 STAMP with longer linker sequences on R. grahamii. 57020-SOD12 STAMP with either 2× (L2) or 3× linkers (L3) was compared to STAMP with 1× linker (57020-SOD12). Kanamycin (100 μg/ml) was used as an antibiotic reference inhibitor. Error bars represent ±standard deviation of the mean (n=3). The peptide dosages shown are in ‘μg/ml’.

FIGS. 17A-17B. Binding of #11 and #12 (binders) to CLas and surrogates (Liberibacter crescens, Rhizobium galegae and Rhizobium grahamii). Peptide binders #11 (FIG. 17A) and #12 (FIG. 17B) were synthesized with FITC labeling. Binding assays were performed using the bacterial cells/extracts and binders (16 μM). DNA DAPI staining was used to identify all cells in a field of view, while FITC fluorescence indicates cells bound by the binders. The two binders bound to putative CLas cells in bacterial extracts from HLB-affected trees, as well as CLas surrogates (L. crescens, R. galegae and R. grahamii) but not to E. coli or to cells in healthy citrus tree extracts. E. coli (FIG. 17A Row A; FIG. 17B, Row G). Bacterial extracts from healthy (FIG. 17A, Row B; FIG. 17B, Row H) or CLas-infected citrus trees (FIG. 17A, Row C; FIG. 17B, Row I). Surrogates L. crescens (FIG. 17A, Row D; FIG. 17B, Row J), R. galegae (FIG. 17A, Row E; FIG. 17B, Row K) and R. grahamii (FIG. 17A, Row F; FIG. 17B, Row L). Scale bar=10 μm.

FIGS. 18A-18B. Efficacy of additional binders on R. grahamii and E. coli. Additional binder treatments on (FIG. 18A) R. grahamii and (FIG. 18B) E. coli. Asterisks (*) represent treatments that were significantly different (p≤0.05) compared to untreated or solvent-alone controls. Error bars represent the ±standard error of the mean (n=3). The peptide dosages shown are in ‘μg’.

FIG. 19. Ramachandran plot for the homology model of BamA. More than 98% of the residues are in favorable regions.

FIGS. 20A-20B. (FIG. 20A) Vina docking scores and (FIG. 20B) MM-GBSA frec energies of HASPs compared with controls. The two HASPs ACT56869.1_241-255 and ACT56973.1_80-96 bind quite strongly to BamA.

FIGS. 21A-21C. (FIG. 21A) Vina docking scores, (FIG. 21B) MM-GBSA scores based on Vina poses and (FIG. 21C) MM-GBSA scores based on protein docking poses for AMPs and STAMPs.

FIG. 22. Attachment of 56869.1_241-255 (red) and ACT56973.1_80-96 (blue) at the binding domain selected for molecular docking. Both peptides bind tightly to the entrance of the barrel.

FIGS. 23A-23E. Variation of RMSD with time for BamA complexed with (FIG. 23A) ACT56869.1_241-255 and (FIG. 23B) ACT56973.1_80-96; RMSF plots for (FIG. 23C) Free BamA protein (FIG. 23D) BamA complexed with ACT56869.1_241-255 and (FIG. 23E) BamA complexed with ACT56973.1_80-96.

FIGS. 24A-24B. Attachment of (FIG. 24A) AMP1_ACT56869.1_241-255 and (FIG. 24B) AMP1_ACT56973.1_80-96 to the top part of the BamA protein. AMP section of the fused peptides are shown in red and targeting peptides are shown in purple.

FIG. 25. Shows examples of linker peptides from Table I of Reddy Chichili V P, Kumar V, Sivaraman J. Linkers in the structural biology of protein-protein interactions. Protein Sci. 2013 February; 22 (2):153-67. doi: 10.1002/pro.2206. Epub 2013 Jan. 8.

FIGS. 26A-26B. Shows in planta efficacy testing of AMP and STAMPS in CLas-citrus composite hairy root plants.

### BRIEF DESCRIPTION OF THE SEQUENCES

SEQ ID NO: 1: Candidatus Liberibacter spp. binding peptide KH_Peptide.

SEQ ID NO: 2: Candidatus Liberibacter spp. binding peptide BamA_27401.

SEQ ID NO: 3: Candidatus Liberibacter spp. binding peptide BamA_22602.

SEQ ID NO: 4: Candidatus Liberibacter spp. binding peptide BamA_02401.

SEQ ID NO: 5: Candidatus Liberibacter spp. binding peptide BamA_01403.

SEQ ID NO: 6: Candidatus Liberibacter spp. binding peptide BamA_10701.

SEQ ID NO: 7: Candidatus Liberibacter spp. binding peptide BamA_03001.

SEQ ID NO: 8: Candidatus Liberibacter spp. binding peptide BamA_03501.

SEQ ID NO: 9: Candidatus Liberibacter spp. binding peptide BamA_46301.

SEQ ID NO: 10: Candidatus Liberibacter spp. binding peptide BamA_00901.

SEQ ID NO: 11: Candidatus Liberibacter spp. binding peptide BamA_00902.

SEQ ID NO: 12: Candidatus Liberibacter spp. binding peptide BamA_56973.

SEQ ID NO: 13: Candidatus Liberibacter spp. binding peptide BamA_56869.

SEQ ID NO: 14: Candidatus Liberibacter spp. binding peptide BamA_57020.

SEQ ID NO: 15: Candidatus Liberibacter spp. binding peptide 1.

SEQ ID NO: 16: Candidatus Liberibacter spp. binding peptide 9.

SEQ ID NO: 17: Candidatus Liberibacter spp. binding peptide 10.

SEQ ID NO: 18: Candidatus Liberibacter spp. binding peptide 11.

SEQ ID NO: 19: Candidatus Liberibacter spp. binding peptide 12.

SEQ ID NO: 20: Candidatus Liberibacter spp. binding peptide 18.

SEQ ID NO: 21: specifically targeted antimicrobial peptide (STAMP) 22602-SOD12.

SEQ ID NO: 22: STAMP SOD12-22602.

SEQ ID NO: 23: STAMP 57020-SOD12.

SEQ ID NO: 24: STAMP SOD12-57020.

SEQ ID NO: 25: STAMP 22602-SOD2*.

SEQ ID NO: 26: STAMP SOD2*-22602.

SEQ ID NO: 27: STAMP 57020-SOD2*.

SEQ ID NO: 28: STAMP SOD2*-57020.

SEQ ID NO: 29: ACT56973.1 Peptide sequence.

SEQ ID NO: 30: ACT56869.1 Peptide sequence.

SEQ ID NO: 31: ACT57020.1 Peptide sequence.

SEQ ID NO: 32: SOD12 (AMP2) peptide.

SEQ ID NO: 33: SOD2* (AMP1) peptide.

SEQ ID NO: 34: Linker sequence.

SEQ ID NO: 35: SOD12 codon optimized genetic sequence.

SEQ ID NO: 36: 22602-SOD12 codon optimized genetic sequence.

SEQ ID NO: 37: SOD12-22602 codon optimized genetic sequence.

SEQ ID NO: 38: 57020-SOD12 codon optimized genetic sequence.

SEQ ID NO: 39: SOD12-57020 codon optimized genetic sequence.

SEQ ID NO: 40: SOD2* codon optimized genetic sequence.

SEQ ID NO: 41: 22602-SOD2* codon optimized genetic sequence.

SEQ ID NO: 42: SOD2*-22602 codon optimized genetic sequence.

SEQ ID NO: 43: 57020-SOD2* codon optimized genetic sequence.

SEQ ID NO: 44: SOD2*-57020 codon optimized genetic sequence.

SEQ ID NO: 45: SOD8 peptide.

SEQ ID NO: 46: SOD9 peptide.

SEQ ID NO: 47: SOD10 peptide.

SEQ ID NO: 48: SOD11 peptide.

SEQ ID NO: 49: SOD13 peptide.

SEQ ID NO: 50: AGM176 peptide.

SEQ ID NO: 51: AGM179 peptide.

SEQ ID NO: 52: MaSAMP peptide.

SEQ ID NO: 53: Plantaricin JLA-9 peptide.

SEQ ID NO: 54: Darobactin peptide.

SEQ ID NO: 55: Urechistachykinin II peptide.

SEQ ID NO: 56: AMPI peptide devoid of leader/signal sequence.

SEQ ID NO: 57: AMP2 peptide devoid of leader/signal sequence.

SEQ ID NO: 58: SOD2_ACT56869 STAMP.

SEQ ID NO: 59: SOD2_ACT56973 STAMP.

SEQ ID NO: 60: SOD2_ACT57020 STAMP.

SEQ ID NO: 61: SOD12_ACT56869 STAMP.

SEQ ID NO: 62: SOD12_ACT56973 STAMP.

SEQ ID NO: 63: SOD12_ACT57020 STAMP.

### DETAILED DISCLOSURE OF THE INVENTION

As used herein, the singular forms “a”, “an” and “the” are intended to include the plural forms as well, unless the context clearly indicates otherwise. To the extent that the terms “including”, “includes”, “having”, “has”, “with”, or variants thereof are used in either the detailed description and/or the claims, such terms are intended to be inclusive in a manner similar to the term “comprising”. The transitional terms/phrases (and any grammatical variations thereof) “comprising”, “comprises”, “comprise”, “consisting essentially of”, “consists essentially of”, “consisting” and “consists” can be used interchangeably.

The phrase “consisting essentially of” or “consists essentially of” indicates that the described embodiment encompasses embodiments containing the specified materials or steps and those that do not materially affect the basic and novel characteristic(s) of the described embodiment.

The term “about” means within an acceptable error range for the particular value as determined by one of ordinary skill in the art, which will depend in part on how the value is measured or determined, i.e., the limitations of the measurement system. In the context of the lengths of polynucleotides where the terms “about” are used, these polynucleotides contain the stated number of bases or base-pairs with a variation of 0-10% around the value (X±10%). In the context of compositions containing amounts of ingredients where the terms “about” or “approximately” are used, these compositions contain the stated amount of the ingredient with a variation (error range) of 0-10% around the stated value (X+10%).

In the present disclosure, ranges are stated in shorthand, so as to avoid having to set out at length and describe each and every value within the range. Any appropriate value within the range can be selected, where appropriate, as the upper value, lower value, or the terminus of the range. For example, a range of 0.1-1.0 represents the terminal values of 0.1 and 1.0, as well as the intermediate values of 0.2, 0.3, 0.4, 0.5, 0.6, 0.7, 0.8, 0.9, and all intermediate ranges encompassed within 0.1-1.0, such as 0.2-0.5, 0.2-0.8, 0.7-1.0, etc. Values having at least two significant digits within a range are envisioned, for example, a range of 5-10 indicates all the values between 5.0 and 10.0 as well as between 5.00 and 10.00 including the terminal values. When ranges are used herein, such as for the size of the peptides, the combinations and sub-combinations of the ranges (e.g., subranges within the disclosed range) and specific embodiments therein, are explicitly included.

The term “organism” as used herein includes animals, fungi and plants. Additional examples of organisms are known to a person of ordinary skill in the art and such embodiments are within the purview of the materials and methods disclosed herein. In certain embodiments, the organism can be a plant, such as, for example, a citrus tree or a potato plant. In certain embodiments, the organism can be an insect, such as, for example, an Asian citrus psyllid or an African citrus psyllid.

As used herein, the term “nucleic acid” or “polynucleotide” refers to deoxyribonucleic acids (DNA) or ribonucleic acids (RNA) and polymers thereof in either single- or double-stranded form. Unless specifically limited, the term encompasses nucleic acids containing known analogs of natural nucleotides that have similar binding properties as the reference nucleic acid and are metabolized in a manner similar to naturally occurring nucleotides. Unless otherwise indicated, a particular nucleic acid sequence also implicitly encompasses conservatively modified variants thereof (e.g., degenerate codon substitutions), alleles, orthologs, single nucleotide polymorphisms (SNPs), and complementary sequences as well as the sequence explicitly indicated. Specifically, degenerate codon substitutions may be achieved by generating sequences in which the third position of one or more selected (or all) codons is substituted with mixed-base and/or deoxyinosine residues (Batzer et al., Nucleic Acid Res. 19:5081 (1991); Ohtsuka et al., J. Biol. Chem. 260:2605-2608 (1985); and Rossolini et al., Mol. Cell. Probes 8:91-98 (1994)). The term nucleic acid is used interchangeably with gene, cDNA, and mRNA encoded by a genc.

As used herein, an “isolated” or “purified” nucleic acid molecule, polynucleotide, polypeptide, protein or organic compound such as a small molecule (e.g., those described below), is substantially free of other compounds, such as cellular material, with which it is associated in nature. A purified or isolated polynucleotide (ribonucleic acid (RNA) or deoxyribonucleic acid (DNA)) is free of the genes or sequences that flank it in its naturally-occurring state. A purified or isolated polypeptide is free of the amino acids or sequences that flank it in its naturally-occurring state.

As used herein, the term “reduce” (and grammatical variants thereof) refers to a negative alteration of at least 1%, 5%, 10%, 25%, 50%, 75%, or 100% with respect to the pathogen population present in the plants affected by the disease within a citrus grove or other agriculture site. In the context of the present invention, “control and/or treatment of citrus greening” “control and/or treatment of a CLas infections” means an improvement in the health and/or production of fruit by citrus plants/trees demonstrating symptoms of citrus greening or health and/or production of potato by potato plants demonstrating symptoms of a CLas infection. Alternatively, the disclosed methods reduce the severity of disease in plants demonstrating symptoms of a disease, including, for example, citrus greening, by reducing the pathogen population present in infected plants/trees.

As used herein, the term “enhance” or “increase” (and grammatical variants thereof) refers to a positive alteration of at least 1%, 5%, 10%, 25%, 50%, 75%, or 100% with respect to, for example, the affinity of antimicrobial peptides (AMPs) towards target proteins.

The subject invention provides for the use of “homologous amino acid sequences” or “homologs of amino acid sequences”. Homologs of amino acid sequences will be understood to mean any amino acid sequence obtained by mutagenesis of the nucleic acid sequence that encodes the amino acid sequence according to techniques well known to persons skilled in the art, and exhibiting modifications in relation to the parent sequences. For example, mutations in the regulatory and/or promoter sequences for the expression of a polypeptide that result in a modification of the level of expression of a polypeptide according to the invention provide for a “homolog of an amino acid sequence”. Likewise, substitutions, deletions, or additions of nucleic acids encoding the polypeptides of the invention provide for “homologs” of amino acid sequences. In various embodiments, “homologs” of amino acid sequences have substantially the same biological activity as the corresponding reference amino acid sequence, i.e., an amino acid homologous to an antimicrobial peptide would encode for a peptide having the same biological activity as the corresponding protein encoded by the reference antimicrobial peptide. Typically, a homolog of an amino acid sequence shares a sequence identity with the reference or parent amino acid of at least about 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or 99%. These percentages are purely statistical and differences between two amino acid sequences can be distributed randomly and over the entire sequence length.

In some aspects of the invention, the disclosed compositions are applied to trees or plants exhibiting symptoms of a plant disease, such as, for example, citrus greening, multiple times, for example the diseased trees or plants are treated approximately every six (6) months. Other embodiments contemplate application of the disclosed compositions in weekly, monthly, quarterly (every three months), and semiannual time frames. Yet other embodiments provide for repeated application of the disclosed compositions in time intervals of “about X months”, “about X weeks”, “about X days”, or “about X hours” where X is an integer selected from 1, 2, 3, 4, 5, 6, 7, 8, 9, 10, 11 or 12. In the context of time where the terms “about” or “approximately” are used, the terms can be construed to include a variation of time on the order of ±two weeks for the period of “months”, ±0.5 day for a period of one (1) day or ±1 day for the period of 2 or more days “days”, ±3 days for a period of one or more weeks, and a period of ±0.5 hour for a period of one hour or a one hour for time periods greater than one hour. In other embodiments, in the context of time, the terms “about” or “approximately” should be construed to include the stated time period and with a variation of 0-50% of the stated time period (hours, days, wecks, or months; e.g., 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, or 50% of the stated time period).

As used herein, “applying” a composition or product refers to contacting it with a target or site such that the composition or product can have an effect on that target or site. The effect can be due to, for example, the action of a peptide.

### Peptide Compositions

In certain embodiments, the subject invention provides a composition comprises one or more peptides that comprise at least one protein binding sequence. In preferred embodiments, the subject invention provides a composition comprising one or more specifically targeted antimicrobial peptides (STAMPs), wherein the STAMP comprises at least one antimicrobial peptide sequence and at least one protein binding sequence, and, optionally, at least one linker sequence that links the antimicrobial peptide sequence to the protein binding sequence. In preferred embodiments, the protein binding sequence comprises a peptide that binds to a bacterial protein, preferably a bacterial surface protein, or, most preferably, the BamA protein. In certain embodiments, the binding peptide is BamA_27401 (MNLSSLSSLLDVR (SEQ ID NO: 2)), BamA_22602 (MGINGFKFLSDIHHFCS (SEQ ID NO: 3)), BamA_02401 (MRIMIDSLSFDSL (SEQ ID NO: 4)), BamA_01403 (MSKISVNEFGLFGKVVV (SEQ ID NO: 5)), BamA_10701 (MSNYGVCHYHSCRSNFSQNSV (SEQ ID NO: 6)), BamA_03001 (MGKSVYIDFVVMDLIISRS (SEQ ID NO: 7)), BamA_03501 (MVGFEDYVNVMW (SEQ ID NO: 8)), BamA_46301 (MDFIRYCYDRFCCDLGMSVTLGNTYRGAGGG (SEQ ID NO: 9)), BamA_00901 (MGLLGLCDLIFYVYNVYWVE (SEQ ID NO: 10)), BamA_00902 (MGLLGLCDLIFYGYNVYWVE (SEQ ID NO: 11)), BamA_56973 (QSFYYVSQKKKWFPVKF (SEQ ID NO: 12)), BamA_56869 (DLHPQFQNLLKKSQN (SEQ ID NO: 13)), BamA_57020 SRNSSIALGLRRAYAVFNYFVARGI (SEQ ID NO: 14)), peptide 1 (FYVTHW (SEQ ID NO: 15)), peptide 9 (FGGSVGGSH (SEQ ID NO: 16)), peptide 10 (FGSGVGSGH (SEQ ID NO: 17)), peptide 11 (WHVTFY (SEQ ID NO: 18)), peptide 12 (WHVTYF (SEQ ID NO: 19)), or peptide 18 (HGGSVGGSF (SEQ ID NO: 20)), ACT56973.1 (QSFYYVSQKKKWFPVKF (SEQ ID NO: 29)), ACT56869.1 (DLHPQFQNLLKKSQN (SEQ ID NO: 30)), ACT57020.1 (SRNSSIALGLRRAYAVFNYFVARGI (SEQ ID NO: 31)), or a homolog thereof.

In certain embodiments, the antimicrobial peptide (AMP) sequence can be a broad-spectrum antimicrobial peptide that can, for example, possess anti-CLas activity. In certain embodiments, the AMPs can be variable in length and properties, including for example, the AMP can have the leader/signal peptide removed. In certain embodiments, the antimicrobial peptide is SOD12 (i.e., AMP2), according to SEQ ID NO: 32 (RICESASYRFKGICVSRSNC ANVCKNEGFPGGRCRGFRRRCLCYKHCG) or according to SEQ ID NO: 57 (RICESASYRFKGICVSRSNCANVCKNEGFPGGRCRGFRRRCLCYKHC; devoid of a leader/signal peptide), SOD2* (i.e., AMPI), according to SEQ ID NO: 33 (GIFSSRKCKTPSKTFKGICTRDSNCDTSCRYEGYPAGDCKGIRRRCLCCTHT) or according to SEQ ID NO: 56 (RKCKTPSKTFKGICTRDSNCDTSCRYEGYPAGDCKGIRR RCLCCTH; devoid of a leader/signal peptide), SOD8 (MKMSMRSIAVVFLVCLLV LSTEEMGPRKADAGFFSSKKCKTPSKTFRGPCVRNANCDTSCRYEGYPAGDCKGIRR RCICCTHA; SEQ ID NO: 45), SOD9 (MKHFGAIFLVLLLVLATEHGARVAEARTCETPS QKFKGICISDSNCESICNTEGFPNGECSGLRRRCICNTPCT; SEQ ID NO: 46), SOD10 (VSTKVAEARICASPSPTFKGICFSSRNCETNCNSVKFSGGSCQGFRRRCMCTKPCA; SEQ ID NO: 47), SOD11 (MRPFAALFLVLFLVLATEIGPRVVEARMCSSPSHRFKGI CTSSRNCENTCNSERFSGGECKGFRRRCMCTGPCV; SEQ ID NO: 48), and SOD13 (MKPFVAFVLAFMLVLAIEMGPRVAEARMCTNPSRTFRGPCVSDRNCESSCMGEGFP GGSCHGFRRKCVCSKPCA; SEQ ID NO: 49), which are each provided in U.S. Pat. No. 10,640,784, which is hereby incorporated by reference in its entirety; AGM176 (FKIKARLRVKIKARLKL; SEQ ID NO: 50) and AGM179 (FRVKARIRLKVKARIRL; SEQ ID NO: 51), which are cach provided in Stover, E., Stange, R. R., Jr., McCollum, T. G., Jaynes, J., Ircy, M., & Mirkov, E. (2013). Screening Antimicrobial Peptides In Vitro for Use in Developing Transgenic Citrus Resistant to Huanglongbing and Citrus Canker, Journal of the American Society for Horticultural Science J. Amer. Soc. Hort. Sci., 138 (2), 142-148, which is hereby incorporated by reference in its entirety; MaSAMP (MCCNRGKNVSIENLHQ GFTHIFESTFESTEGVAEYVSHPAHVEYANLFLANLEKVLVIDYKPTTVRV; SEQ ID NO: 52), which is provided in Huang C Y, Araujo K, Sanchez J N, Kund G, Trumble J, Roper C, Godfrey K E, Jin H. A stable antimicrobial peptide with dual functions of treating and preventing citrus Huanglongbing. Proc Natl Acad Sci USA. 2021 Feb. 9; 118(6):e2019628118, which is hereby incorporated by reference in its entirety; Plantaricin JLA-9 (FWQKMSFA; SEQ ID NO: 53), Darobactin (WNWSKSF; SEQ ID NO: 54), and Urechistachykinin II (AAGMGFFGAR: SEQ ID NO: 55), which are each provided in Wang H, Mulgaonkar N, Mallawarachchi S, Ramasamy M, Padilla C S, Irigoyen S, Coaker G, Mandadi K K, Fernando S. Evaluation of Candidatus Liberibacter Asiaticus Efflux Pump Inhibition by Antimicrobial Peptides. Molecules. 2022 Dec. 9; 27(24):8729, which is hereby incorporated by reference in its entirety.

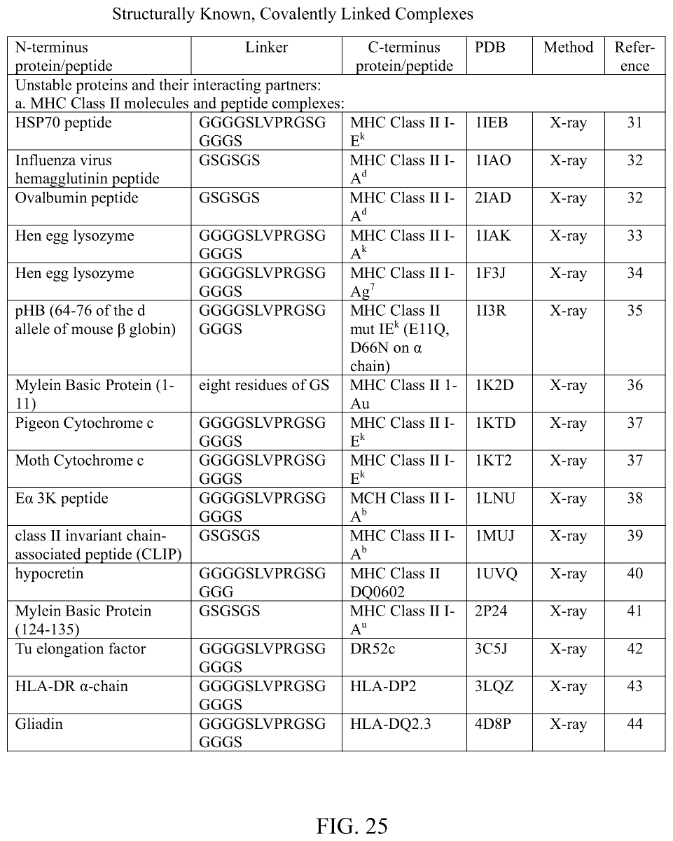

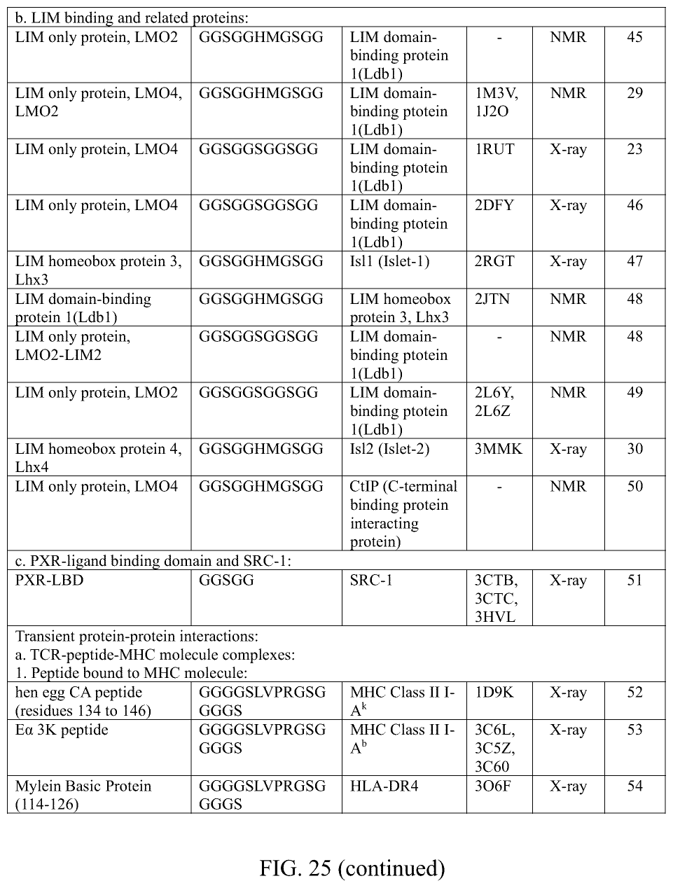

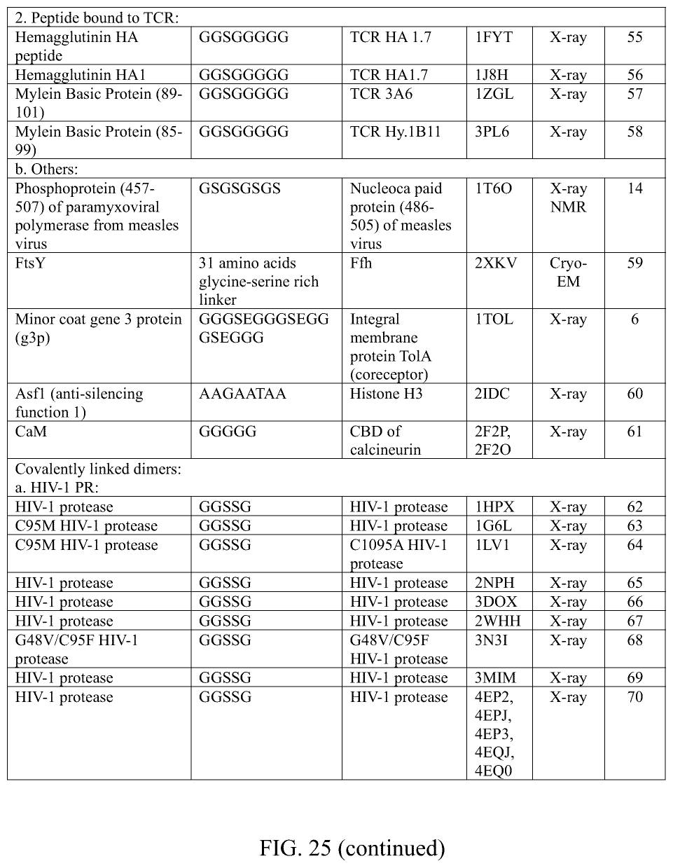

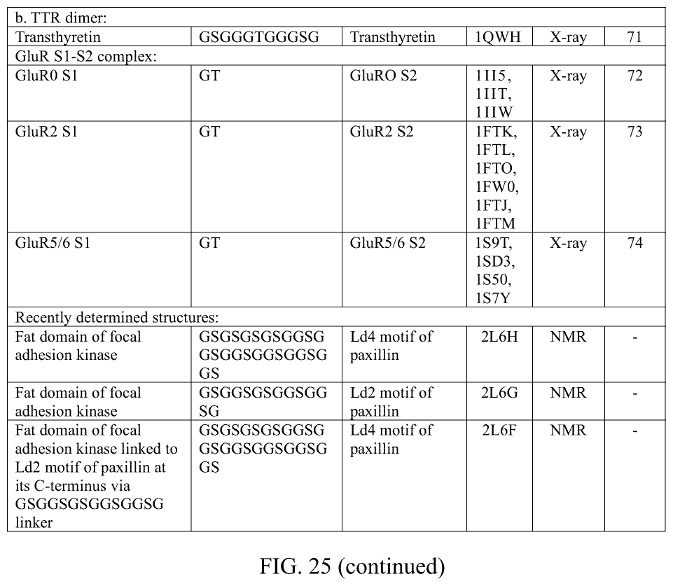

In certain embodiments, the linker sequence links the protein binding sequence to the antimicrobial peptide sequence. In certain embodiments, the linker sequence is an inert sequence, such as, for example, GGSGGS (SEQ ID NO: 34) or multimers thereof. In certain embodiments, other linker sequences known in the art can be used to bind the protein binding sequence to the antimicrobial peptide sequence, including, for example, linkers described in Table I of Reddy Chichili V P, Kumar V, Sivaraman J. Linkers in the structural biology of protein-protein interactions. Protein Sci. 2013 February; 22(2):153-67. doi: 10.1002/pro.2206. Epub 2013 Jan. 8, which is hereby incorporated by reference in its entirety (FIG. 25).

In certain embodiments, the STAMPs of the subject invention are 22602-SOD12 (MGINGFKFLSDIHHFCSGGSGGSRICESASYRFKGICVSRSNCANVCKNEGFPGGRCR GFRRRCLCYKHCG (SEQ ID NO: 21)), SOD12-22602 (RICESASYRFKGICVSRSNCAN VCKNEGFPGGRCRGFRRRCLCYKHCGGGSGGSMGINGFKFLSDIHHFCS (SEQ ID NO: 22)), 57020-SOD12 (SRNSSIALGLRRAYAVFNYFVARGIGGSGGSRICESASYR FKGICVSRSNCANVCKNEGFPGGRCRGFRRRCLCYKHCG (SEQ ID NO: 23)), SOD12-57020 (RICESASYRFKGICVSRSNCANVCKNEGFPGGRCRGFRRRCLCYKHCGGGSG GSSRNSSIALGLRRAYAVFNYFVARGI (SEQ ID NO: 24)), 22602-SOD2* (MGINGFKFLSDIHHFCSGGSGGSGIFSSRKCKTPSKTFKGICTRDSNCDTSCRYEGYP AGDCKGIRRRCLCCTHT (SEQ ID NO: 25)), SOD2*-22602 (GIFSSRKCKTPSKTFKGI CTRDSNCDTSCRYEGYPAGDCKGIRRRCLCCTHTGGSGGSMGINGFKFLSDIHHFCS (SEQ ID NO: 26)), 57020-SOD2* (SRNSSIALGLRRAYAVFNYFVARGIGGSGGSGIFS SRKCKTPSKTFKGICTRDSNCDTSCRYEGYPAGDCKGIRRRCLCCTHT (SEQ ID NO: 27)), SOD2*-57020 (GIFSSRKCKTPSKTFKGICTRDSNCDTSCRYEGYPAGDCKGIRRR CLCCTHTGGSGGSSRNSSIALGLRRAYAVFNYFVARGI (SEQ ID NO: 28)), SOD2_ACT56869 (RKCKTPSKTFKGICTRDSNCDTSCRYEGYPAGDCKGIRRRCLCC THDLHPQFQNLLKKSQN (SEQ ID NO: 58)), SOD2_ACT56973 (RKCKTPSKTFKGICTR DSNCDTSCRYEGYPAGDCKGIRRRCLCCTHQSFYYVSQKKKWFPVKF (SEQ ID NO: 59)), SOD2_ACT57020 (RKCKTPSKTFKGICTRDSNCDTSCRYEGYPAGDCKGIRRRC LCCTHSRNSSIALGLRRAYAVFNYFVARGI (SEQ ID NO: 60)), SOD12_ACT56869 (RICESASYRFKGICVSRSNCANVCKNEGFPGGRCRGFRRRCLCYKHCDLHPQFQNLL KKSQN (SEQ ID NO: 61)), SOD12_ACT56973 (QSFYYVSQKKKWFPVKFRICESASYR FKGICVSRSNCANVCKNEGFPGGRCRGFRRRCLCYKHC (SEQ ID NO: 62)), SOD12_ACT57020 (RICESASYRFKGICVSRSNCANVCKNEGFPGGRCRGFRRRCLCY KHCSRNSSIALGLRRAYAVFNYFVARGI (SEQ ID NO: 63)), or a homolog thereof.

In certain embodiments, a homolog of an amino acid sequence can comprise an amino acid sequence that varies from a reference amino acid sequence by at least 1, 2, 3, 4, 5, 6, 7, 8, 9, or 10 amino acid residues. For example, the protein binding sequence BamA_00901 (MGLLGLCDLIFYVYNVYWVE (SEQ ID NO: 10)) varies by a single amino acid when compared to protein binding sequence BamA_00902 (MGLLGLCDLIFYGYNVYWVE (SEQ ID NO: 11)). Additionally, the protein binding sequence of peptide 9 (FGGSVGGSH (SEQ ID NO: 16)) varies by three amino acid residues compared to peptide 10 (FGSGVGSGH (SEQ ID NO: 17)).

In certain embodiments, agriculturally acceptable solvents can be used in a composition comprising the peptides of the subject invention. In certain embodiments, peptides that are not soluble in aqueous solutions can, first, be solubilized in organic solvents and then dispersed in a carrier (e.g., water). Suitable organic solvents include all polar and non-polar organic solvents usually employed for formulation purposes. Non-limiting examples of organic solvents include acetonitrile, ketones, e.g. acetone, methyl ethyl ketone, methyl isobutyl ketone or cyclohexanone, amides, e.g. dimethyl formamide and alkanccarboxylic acid amides, e.g. N,N-dimethyl decancamide and N,N-dimethyl octanamide, cyclic solvents, e.g. N-methyl-pyrrolidone, N-octyl-pyrrolidone, N-dodecyl-pyrrolidone, N-octyl-caprolactame, N-dodecyl-caprolactame and butyrolactone, strong polar solvents, e.g. dimethylsulfoxide, and aromatic hydrocarbons, e.g. xylol, mineral oils, e.g. white spirit, petroleum, alkyl benzenes and spindle oil, esters, e.g. propyleneglycol-monomethylether acetate, adipic acid dibutylester, acetic acid hexylester, acetic acid heptylester, citric acid tri-n-butylester and phthalic acid di-n-butylester, and alcohols, e.g. methanol, ethanol, propanol, benzyl alcohol and 1-methoxy-2-propanol. For soluble peptides, water or any other aqueous solution can be used to solubilize the peptide.

In certain embodiments, agriculturally acceptable carriers: A carrier is a natural or synthetic, organic or inorganic substance which is mixed or combined with the peptides for better applicability, in particular for application to plants. The carrier is generally inert and should be suitable for use in agriculture. Non-limiting examples of carriers include water, alcohols (such as ethanol, propanol or butanol), organic solvents, mineral and vegetable oils, and derivatives thereof. Various mixtures of carriers can be used.

The compositions according to the invention can comprise ready-to-use compositions which can be applied with suitable apparatus to a plant or a commercial concentrate (formulation) that has to be diluted with, for example, water prior to use. Thus, the disclosed compositions may be in the form of a commercial/concentrated formulation or in a diluted form suitable for application to diseased plants (e.g., mixed with other active ingredients, such as insecticides, attractants, sterilants, biostimulants, biocontrol agents, bactericides, acaricides, nematicides, fungicides, growth regulators, herbicides, fertilizers, and/or safeners).

In various aspects of the invention, the composition, in a commercial form/formulation, comprises between about 1% and about 99.9995% by weight, about 1% and about 99.995% by weight, between about 1% and about 99.95% by weight, between about 1% and about 99.95% by weight, about 1.25% to about 99.5% by weight, about 5% to about 99.5% by weight, or between about 5% and about 99% by weight of one or more of the following components: agriculturally suitable solvents or agriculturally suitable carriers. Various embodiments provide for amounts of agriculturally suitable solvents and/or agriculturally suitable carriers in an amount of about 1%, about 1.25%, about 2.5%, about 5%, about 7.5%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, about 99.5%, about 99.95%, about 99.995%, or about 99.9995%. Typically, the amount of peptides present in a composition is between 5 μg/ml to about 500 μg/ml, about 10 μg/ml to about 250 μg/ml, about 25 μg/ml to about 100 μg/ml, or about 50 μg/ml to about 100 μg/ml. As is apparent, the total weight of the composition is 100%, thus, if the peptide (or combination of peptides) represents.005% of the composition by weight, agriculturally suitable solvents and/or agriculturally suitable carriers account for the other 99.995% of the composition by weight.

### Methods of Controlling or Inhibiting Bacterial Infection of Plants

In certain embodiments, the subject peptides or compositions thereof can be applied to a plant, including, for example, to the leaves, stem, roots or injected into the interior of the plant.

In certain embodiments, the peptides can inhibit or control a bacterial infection in plants by Candidatus Liberibacter spp., including, for example, Candidatus Liberibacter asiaticus, Candidatus Liberibacter africanus, and Candidatus Liberibacter americanus; Liberibacter crescens; Rhizobium galegae; or Rhizobium grahamii.

Exemplary plants that can be treated in accordance with the disclosed compositions include any cultivar from the genus Citrus, including but not limited to Citrus sinensis, lemon (C. limon), Persian lime (C. latifolia), grapefruit (C. paradisi), sour orange (C. aurantium), and mandarin (C. reticulata). Thus, according to a specific embodiment, the citrus plant or tree includes, but is not limited to, all citrus species and subspecies, including sweet oranges of commercial varieties (Citrus sinensis Osbeck (L.)), clementines (C. clementina), mandarin oranges (C. reticulata), key limes (C. aurantifolia), lemon (C. limon), sour orange (C. aurantium), hybrids and relatives (Citranges, Citrumelos, Citrandarins), Balsamocitrus dawei, C. maxima, C. jambhiri, Clausena indica, C. lansium, Triphasia trifolia, Swinglea glutinosa, Micromellum tephrocarpa, Merope spp., Eremolemon, Atalantia spp., Severinia buxifolia, Microcitrus spp., Fortunella spp., Calodendrum capense, Murraya spp. and Poncirus trifoliata. In some embodiments the citrus plant is an orange, a lemon, a lime, a grapefruit, a clementine, a tangerine, a tangelo or a pomelo tree. In certain embodiments, the plant is a potato plant, including, for example, Solanum spp., such as, for example, S. stenotomum, S. phureja, S. goniocalyx, S. ajanhuiri, S. chaucha, S. juzepczukii, S. curtilobum, and the two major subspecies of Solanum tuberosum: Solanum tuberosum subsp. andigena and Solanum tuberosum subsp. tuberosum.

The subject invention also provides for methods for controlling and/or treating CLas infections in plants, particularly citrus greening disease in citrus plants and potato zebra chip disease in potato plants, comprising the administration of a composition comprising the peptides of the subject invention. Typically, the composition is administered to the plant as “an application formulation”. For example, the compositions can be administered (applied) to plants by foliar spray, leaf etching, root infusion or drenching, or injection into the vasculature. Plants typically receive foliar spray application of fungicides, insecticides, and/or nutritionals. Most foliar sprays are applied by airblast sprayers. Thus, in one embodiment, compositions disclosed within this application are applied via foliar spray to plants.

In certain embodiments, delivering the disclosed compositions to plants comprises delivering the composition to the plants using irrigation systems. Exemplary irrigation systems that can be used to deliver the disclosed compositions to plants (via an injection system that introduce the composition into the water supply) include microjets (low volume systems with sprinklers adjacent to each plant or between two plants), flood irrigation, or overhead sprinklers. Typically, a commercial form of the disclosed composition would be injected into the irrigation system in an amount that delivers peptide(s) in amounts that correspond to an “application formulation” when irrigation is applied to a plant.

In certain embodiments, delivering the disclosed composition to the plant can be performed by trunk feeding either by injection or by external application. The delivery efficiency by the injection method is near 100% as the entire volume is forced into the vascular system of the tree or plant.

In certain embodiments, the BamA protein of CLas is selected as the main target protein for targeting by the subject peptides. In certain embodiments, the β-barrel assembly mechanism (BAM), a complex consisting of 5 components, is responsible for proper folding of β-barrel proteins and their insertion into outer membrane. BamA protein, which is an OMP itself, is an integral component of BAM complex [21-25]. The β-barrel domain of the BamA protein is tethered to the outer membrane of the cell, which allows the insertion of OMPs to the outer membrane [21, 22]; and the transport of substrates through the β-barrel is regulated by the partial separation of 1^{st} and 16^{th} β strands [23, 24]. The critical importance of BamA for the bacterial functioning, and its connection to outer membrane makes BamA an ideal target protein.

In certain embodiments, CLas-hairy roots, which are hairy root cultures that support CLas bacterial growth, can be used to screen antimicrobials, such as, the subject STAMPs. The CLas-hairy roots can be treated with various STAMPs of the subject invention over a period of about 1 hour to about 1 weck or about 72 hours. Additionally or alternatively, transgenic hairy roots encoding the STAMPs can be used to evaluate the efficacy of the STAMPs against CLas infections.

The present invention is not limited to any particular method for transforming plant cells. Technology for introducing DNA into plant cells is well-known to those of skill in the art. Four basic methods for delivering foreign DNA into plant cells have been described. Chemical methods (Graham and van der Eb, 1973; Zatloukal et al., 1992); physical methods including microinjection (Capecchi, 1980), electroporation (Wong and Neumann 1982; Fromm et al., 1985; U.S. Pat. No. 5,384,253) and the gene gun (Johnston and Tang, 1994; Fynan et al., 1993); viral methods (Clapp, 1993; Lu et al., 1993; Eglitis and Anderson 1988; Eglitis et al., 1988); and receptor-mediated methods (Curiel et al., 1991; Curiel et al., 1992; Wagner et al., 1992).

The introduction of DNA into plant cells by means of electroporation is well-known to those of skill in the art. Plant cell wall-degrading enzymes, such as pectin-degrading enzymes, are used to render the recipient cells more susceptible to transformation by electroporation than untreated cells. To effect transformation by electroporation one may employ either friable tissues such as a suspension culture of cells, or embryogenic callus, or immature embryos or other organized tissues directly. It is generally necessary to partially degrade the cell walls of the target plant material with pectin-degrading enzymes or mechanically wounding in a controlled manner. Such treated plant material is ready to receive foreign DNA by electroporation.

Another method for delivering foreign transforming DNA to plant cells is by microprojectile bombardment. In this method, microparticles are coated with foreign DNA and delivered into cells by a propelling force. Such micro particles are typically made of tungsten, gold, platinum, and similar metals. An advantage of microprojectile bombardment is that neither the isolation of protoplasts (Cristou et al., 1988) nor the susceptibility to Agrobacterium infection is required. An illustrative embodiment of a method for delivering DNA into maize cells by acceleration is a Biolistics Particle Delivery System, which can be used to propel particles coated with DNA or cells through a screen onto a filter surface covered with corn cells cultured in suspension. The screen disperses the particles so that they are not delivered to the recipient cells in large aggregates. For the bombardment, cells in suspension are preferably concentrated on filters or solid culture medium. Alternatively, immature embryos or other target cells may be arranged on solid culture medium. The cells to be bombarded are positioned at an appropriate distance below the macroprojectile stopping plate. In bombardment transformation, one may optimize the prebombardment culturing conditions and the bombardment parameters to yield the maximum numbers of stable transformants. Both the physical and biological parameters for bombardment are important in this technology. Physical factors are those that involve manipulating the DNA/microprojectile precipitate or those that affect the flight and velocity of either microprojectiles. Biological factors include all steps involved in manipulation of cells before and immediately after bombardment, the osmotic adjustment of target cells to help alleviate the trauma associated with bombardment, and also the nature of the transforming DNA, such as linearized DNA or intact supercoiled plasmids.

Agrobacterium-mediated transfer is a widely applicable system for introducing foreign DNA into plant cells because the DNA can be introduced into whole plant tissues, eliminating the need to regenerate an intact plant from a protoplast. The use of Agrobacterium-mediated plant integrating vectors to introduce DNA into plant cells is well known in the art. See, for example, the methods described in Fraley et al. (1985) and Rogers et al. (1987). Further, the integration of the Ti-DNA is a relatively precise process resulting in few rearrangements. The region of DNA to be transferred is defined by the border sequences, and intervening DNA is usually inserted into the plant genome as described in Spielmann et al. (1986) and Jorgensen et al. (1987).

Agrobacterium or Rhizobium transformation vectors are capable of replication in E. coli as well as Agrobacterium or Rhizobium, allowing for convenient manipulations. Moreover, recent technological advances in vectors for Agrobacterium-mediated gene transfer have improved the arrangement of genes and restriction sites in the vectors to facilitate construction of vectors capable of expressing various proteins or polypeptides. Convenient multi-linker regions flanked by a promoter and a polyadenylation site for direct expression of inserted polypeptide coding genes are suitable for present purposes. In addition, Agrobacterium containing both armed and disarmed Ti genes can be used for the transformations. In certain embodiments, a viral vector, such as, for example, a citrus tristeza virus viral vector (CTVvv), can be used to encode various proteins or polypeptides, including, for example, the subject STAMPs. Subsequently, the CTVvv can be used to for encoding exogenous genes and synthesizing the encoded proteins or polypeptides in plants, including, for example, citrus trees. In preferred embodiments, the vector can encode a nucleotide sequence of Table 3.

Transformation of plant protoplasts can be achieved using methods based on calcium phosphate precipitation, polyethylene glycol treatment, electroporation, and combinations of these treatments (scc, e.g., Potrykus et al., 1985; Marcotte et al., 1988). Application of these systems to different plant species depends on the ability to regenerate the particular species from protoplasts.

In certain embodiment, an additive that facilitates the uptake of the subject peptide compositions into the leaf (penetrant) can be incorporated into the formulation of the peptide composition or can be added applied to a leaf before or after application of the peptide composition. In certain embodiments, the penetrant can be, for example, fosetyl-Al, phosphorous acid, potassium phosphite, crop oil concentrates, vinclozolin, or iprodione.

### Materials and Methods

### Design and Development of CLas Binding Peptides and STAMPs

For the in silico modeling approach, we used a combination of methods and software, including ELIXIR-A, ZDOCK, and Autodock Vina, for the in silico docking experiments, using homology models of CLas BamA.

STAMP Design and Peptide Synthesis A series of STAMPs comprised of different components were designed by linking individual CLas binding peptides to a broad-spectrum antimicrobial peptide (AMP, SOD12) from spinach with anti-CLas activity [9]. An inert amino acid linker sequence (GGSGGS) was used for the conjugation in two orientations (N- and C-terminus fusion). The AMP, CLas binders alone, and the STAMPs were further synthesized by Lifetein (CA, USA). Briefly, peptides were synthesized on a pre-loaded 2-Cl-Trt resin (for peptides with a free carboxylic acid at the C-terminal) or Rink Amide MBHA resin (for peptides with C-terminal amidation) using standard Fmoc synthesis protocol with DIC/HOBt coupling, on an APEX 396 automatic synthesizer. The resin was swollen in DMF for 30 min, treated with 20% Piperidine-DMF for 8 minutes to remove the Fmoc protecting group at room temperature, and washed three times with DMF. For the coupling reaction, the resin was added with Fmoc-protected amino acid, HOBt, DIC, and NMP. The mixture was vortexed for 20 minutes at room temperature. Subsequently, the resin was washed with DMF once. The deprotection and coupling steps cycle was repeated until the last amino acid residue was assembled. The resin was then washed with DMF and DCM and dried with air. For three hours, the peptides were cleaved using a TFA cocktail (95% TFA, 2.5% water, and 2.5% TIS). Crude peptides were precipitated by adding ice-chilled anhydrous ethyl ether, washed with anhydrous ethyl ether three times, and vacuum dried. After the synthesis, we used the conventional prep-HPLC for peptide purification. All peptide QC was performed on HPLC and MS.

### Bacterial Cultivation, Growth Media, and Peptide Binding Assays

All bacterial starter cultures were grown in their respective growth media. R. grahamii and R. galegae were grown in TY medium (5 g Bacto Tryptone, 3 g Yeast Extract, 1.3 g CaCl2* 6H2O, deionized water to 1 L; add 15 g/L for solid media). L. crescens was grown in BM7 medium (2 g α-Ketoglutarate, 10 g ACES buffer, 3.75 g KOH, deionized water 550 ml, 15 g agar [for solid media], adjusted pH to 6.7-6.9, and autoclaved at 121° C. After cooling, aseptically add 150 ml Fetal Bovine Serum and 300 ml TMN-FH Medium [Sigma T1032]. E. coli was grown in a standard LB medium. Cells were incubated in a shaker (200 rpm) at 28° C. for R. grahamii (48 h), R. galegae (48 h), and L. crescens (5 to 7 days) and at 37° C. for E. coli (overnight). Because CLas remains unculturable, a bacterial extract was prepared from HLB-infected and healthy plant tissues. All pelleted cells/extracts were washed with 0.5 mL PBS, and then FITC-labeled peptides were added at 16 μM final concentration in PBS. The samples were incubated for 5 min at 25° C. and washed with 0.5 mL PBS. DAPI staining was also performed to mark all DNA-containing cells. DAPI was added to the cells and incubated for 1 min at 25° C., followed by two washes with 0.5 mL PBS. The final bacterial pellet was resuspended in 20-50 μL PBS. Microscope slides were prepared by adding ˜5 μL FITC-labeled bacterial suspension to a drop of glycerol. Imaging was carried out in an Olympus BX51 (Olympus LifeScience, Waltham, MA) microscope under 100× (immersion oil) magnification, and images for both DAPI and FITC fluorescence were taken.

### Cell Density-Based Efficacy Assays

R. grahamii and E. coli starter cultures were prepared in ˜3 ml of TY and LB medium to an OD of 0.5-0.7. Subsequently, for the efficacy assays, cells were resuspended to a final OD of 0.1 in 500 μL YM media for R. grahamii and LB media for E. coli supplemented with the respective peptides (0, 10, 25, 50, or 100 μg/ml), or antibiotic (Kanamycin 100 μg/mL) and solvent alone controls (Acetonitrile 1.25% v/v). All assays were performed in triplicate in a transparent 96-well U-bottom multi-well plate with a lid to prevent evaporation (Corning Falcon, Fisher Scientific, Hampton, NH). The assay plates were placed in a SYNERGY H1 Microplate reader (Agilent, Santa Clara, CA) equipped with Gen5 3.0 software (Agilent, Santa Clara, CA). The plates were incubated at 28° C. with continuous shaking. OD600 reads were measured every hour until untreated controls reached OD600 of ˜1.

### Bacterial Cell Viability-Based Efficacy Assays

R. galegae cells were grown overnight at 28° C., 200 rpm in 3 mL TY. For L. crescens, a 3 mL culture was grown in BM7 for four days. Cells were harvested by centrifugation of 1 mL of the culture at 7,000×g and were washed three times with 0.85% NaCl and diluted to OD600 of 0.1 with 0.85% NaCl. Cells were subsequently transferred to a microtiter plate, and peptides were added at different dosages (25, 50, or 100 μg/mL). The cells were treated for three h at 28° C. on a plate shaker at ˜280 rpm, alongside untreated controls. All cells were collected into a 1.5 ml tube and centrifuged at 10,000×g for 10 minutes. The supernatant was discarded, and cells were resuspended with 100 μl of 0.85% NaCl. As a positive control, cells were collected and boiled for 5 minutes. Viable and dead cells were distinguished using a Viability/Cytotoxicity assay kit for bacteria (Cat #30027, Biotium, Fremont, CA). The assay utilizes DMAO (Ex/Em 496/528 nm) and ethidium homodimer III (EthD-III, Ex/Em 279, 532/625 nm) to stain all and dead cells, respectively. One μL of the dye mix was added to each treatment and incubated at room temperature for 15 minutes in the dark. Cells were subsequently imaged using an Olympus BX51 (Olympus LifeScience, Waltham, MA) fluorescence microscope under a 60× (Immersion oil) objective. Representative images were taken, and the % mortality was calculated from an average of five to six replicates for each treatment.

### CLas-Citrus Hairy Root Efficacy Assays and Molecular Diagnostics

The CLas-citrus hairy root assay was performed according to the previously described protocol⁹. Briefly, CLas-hairy roots were surface sterilized and ˜100 mg transferred into multi-well plates containing Gamborg's B-5 medium with 1% sucrose. Different binders and peptides (10, 50, and 100 μg/mL) were added to the medium. The plate was vacuum infiltrated at ˜20 psi to facilitate the penetration of the peptides into the hairy root matrices. All assays were carried out with ˜5 biological replicates, alongside untreated controls, solvent alone (Acetonitrile 0.6% and 1.25% v/v), an unrelated GFP peptide control, and a CLas inhibitor/antibiotic control (Cinoxacin, 50 μM). The assay plates were incubated on a rotator shaker (Thermo Fisher Scientific, Waltham, MA, USA) at 50 rpm in the dark at 25° C. for 72 h. The hairy root tissues were collected after 72 h, treated with PMAxx, and subsequently flash-frozen in liquid nitrogen and stored at −80° C. for further processing. PMAxx treatment before DNA isolation allows the inactivation of DNA of dead cells. The root samples were homogenized using a Precellys 24 (MO BIO Laboratories, Carlsbad, CA, USA), and DNA extractions were carried out with the CTAB method. The quality and quantity of DNA were determined using a NanoDrop One Spectrophotometer (Thermo Fisher Scientific, Waltham, MA). Approximately 25 ng of DNA was used for qPCR analysis, performed on a CFX384™ Real-Time PCR Detection System (Bio-Rad Laboratories, Hercules, CA) using iTaq™ universal SYBR® Green supermix (Bio-Rad Laboratories, Hercules, CA), according to the manufacturer's instructions. Primers for the CLas gene encoding the ribonucleotide reductase β-subunit (nrdB, RNR-F/RNR-R) (Hocquellet et al. 1999 and Zheng et al. 2016) were used to detect CLas. Relative CLas titers were estimated using the 2^{-ΔΔ}Ct method. CLas Ct values were normalized to the citrus glyceraldehyde3-phosphate dehydrogenase 2 (GAPC2) (Mafra et al. 2012) amplicon Ct to account for the DNA template quantity/quality differences that may exist among the PCR reactions. Ct values were plotted relative to the level in control (untreated) CLas hairy root samples, which was set to 100%. The student's 1-test was used to determine statistically significant (p≤0.01) differences between the controls and treatments.

### Materials

CLas BamA protein was expressed in-vitro by GenScript based on already published

peptide sequences [32]. HASPs and control peptide CL_BamA_22602 were custom synthesized by GenScript based on sequences provided by the authors. pH 6.5 Tris buffer, Triton-X-100 and dimethylsulfoxide (DMSO) were purchased from VWR, USA.

### Homology Modeling of BamA and AMPs

FASTA sequence of CLas BamA protein was obtained from UniProtKB database (UniProtKB ID: Q32TE9) and was verified using NCBI BLAST sequence comparison algorithm [33]. This sequence was used to develop a homology model using SWISS-MODEL server [34]. Fifteen structures which showed more than 25% sequence similarity with CLas BamA were used as templates when building homology model. From the output models, the most accurate model was selected based on GMQE (Global Mean Quality Estimation) and QMEAN (Quantitative Model Energy Analysis). The Ramachandran plot for the developed protein structure was prepared using PROCHECK [35].

Homology models for the AMPs were built with SWISS-MODEL. Among the peptides which showed high sequence similarity and GMQE to the AMPs, flower-specific gamma-thionin (RCSB PDB ID: 6dmz) [36] was selected as the template, since thionins show antimicrobial properties and over-expression of thionins has been reported to increase resistance against HLB [18, 27].

### Screening of High-Affinity Short Peptides

Proteins which have been reported to interact with BamA and proteins which can be predicted to interact with BamA based on factors such as gene neighborhood and protein homology were screened using STRING database [37]. Interactions of the selected proteins with BamA were analyzed using the protein-protein docking tool in Schrödinger®. Based on those results, the peptide chains that interacted most often with OMP were identified. Identified peptide segments were cropped using Schrödinger Maestro.

### Molecular Docking and Simulations

The binding of the selected peptides to BamA was evaluated via AutoDock Vina docking [38]. The top part of the β-barrel was selected as the binding domain, since attachment of a ligand to that section can potentially hinder substrate access to the interior of the protein. Prior to all simulations and docking, proteins and peptides were optimized and minimized, and the termini of BamA were capped using the protein preparation wizard in Schrödinger Maestro®.

Once the HASPs were screened, UCSF Chimera® was used to fuse the N terminus of AMPs with C terminus of HASPs to synthesize STAMPs [39], which were also subjected to docking simulations using Autodock vina.

Binding affinity of peptides was further evaluated using Prime MM-GBSA (Molecular mechanics-generalized Born surface area) energy analysis. The MM-GBSA calculations were performed using poses obtained from AutoDock Vina and Schrödinger protein-protein docking. The interactions of the peptides with BamA protein were evaluated using the Ligand Interaction analysis tool in Schrödinger. VMD [40] and Schrödinger Maestro were used for the visualization of simulation and docking results.

Molecular dynamics simulations were performed using Schrödinger Desmond. Proteins prepared using protein preparation wizard were setup using system builder. Solvation was done using TIP4P solvent model and OPLS_2005 force field, and the system was neutralized by addition of Na⁺ or Cl⁻ ions. The membrane was placed using POPC membrane model with beta-sheets as transmembrane atoms. Molecular dynamics simulations were executed for 20 ns with a recording interval of 20 ps, under NPT ensemble at 300 K and 1.01325 bar. The system was relaxed prior to simulation using the default relaxation protocol in Desmond. Once the simulation was complete, Root Mean Square Deviation (RMSD) at each time point and Root Mean Square Fluctuation (RMSF) for each residue were calculated and plotted using simulation event analysis tool.

### Bio-Layer Interferometry

The binding kinetics of HASPs on BamA were evaluated using the ForteBio BLItz® system. Experiments were conducted on advanced kinetics mode using aminopropylsilane (APS) biosensors. pH 6.5 Tris buffer was used for the preparation of all solutions. Initially, the biosensors were hydrated in the buffer for 10 minutes, followed by a 30-second baseline step. BamA protein was loaded on the biosensors by immersing the biosensors for 300 seconds in a 5 mg/L protein solution, followed by another 30-second baseline step for stabilization of protein on the sensor. Association and dissociation steps were carried out for 300 s and 600 s, respectively. For each compound, association and dissociation profiles were determined at five different concentrations at two-fold serial dilutions, with a zero-concentration sample for baseline. Association and dissociation constants were calculated using BLItz Pro 1.3 software based on the binding curves using a global-fitting model. All experiments were carried out in triplicate.

All patents, patent applications, provisional applications, and publications referred to or cited herein are incorporated by reference in their entirety, including all figures and tables, to the extent they are not inconsistent with the explicit teachings of this specification.

Following are examples which illustrate procedures for practicing the invention. These examples should not be construed as limiting. All percentages are by weight and all solvent mixture proportions are by volume unless otherwise noted.

### EXAMPLE 1—BACTERIAL TARGETING PEPTIDES

We used two approaches to design CLas targeting peptides. First, an aptamer peptide selection approach was employed. This approach used an in vitro selection process [11] against a portion of the CLas BamA protein found on the cell's surface, which was expressed and purified in vitro as previously described [12]. We chose to use CLas BamA protein because it was also successfully used to create an effective CLas antibody [12]. As a complementary approach, we also employed a computational modeling approach. This approach involved protein modeling of BamA and in silico docking simulations of ligands to identify effective CLas BamA binding peptides. We identified 13 potential CLas BamA binding peptides (Table 1).

TABLE 1
List of potential Candidatus Liberibacter spp. binding peptides identified from
aptamer selection and in silico modeling.

| Binder ID | Sequence | Source |
|---|---|---|
| KH_Peptide | KKHRKHRKHRKH (SEQ ID NO: 1) | Aptamer selection |
| BamA_27401 | MNLSSLSSLLDVR (SEQ ID NO: 2) | Aptamer selection |
| BamA_22602 | MGINGFKFLSDIHHFCS (SEQ ID NO: 3) | Aptamer selection |
| BamA_02401 | MRIMIDSLSFDSL (SEQ ID NO: 4) | Aptamer selection |
| BamA_01403 | MSKISVNEFGLFGKVVV (SEQ ID NO: 5) | Aptamer selection |
| BamA_10701 | MSNYGVCHYHSCRSNFSQNSV (SEQ ID NO: 6) | Aptamer selection |
| BamA_03001 | MGKSVYIDFVVMDLIISRS (SEQ ID NO: 7) | Aptamer selection |
| BamA_03501 | MVGFEDYVNVMW (SEQ ID NO: 8) | Aptamer selection |
| BamA_46301 | MDFIRYCYDRFCCDLGMSVTLGNTYRGAGGG | Aptamer selection |
| | (SEQ ID NO: 9) | |
| BamA_00901 | MGLLGLCDLIFYVYNVYWVE (SEQ ID NO: 10) | Aptamer selection |
| BamA_00902 | MGLLGLCDLIFYGYNVYWVE (SEQ ID NO: 11) | Aptamer selection |
| BamA_56973 | QSFYYVSQKKKWFPVKF (SEQ ID NO: 12) | In silico modeling |
| BamA_56869 | DLHPQFQNLLKKSQN (SEQ ID NO: 13) | In silico modeling |
| BamA_57020 | SRNSSIALGLRRAYAVFNYFVARGI (SEQ ID | In silico modeling |
| | NO: 14) | |
| 1 | FYVTHW (SEQ ID NO: 15) | In silico modeling |
| 9 | FGGSVGGSH (SEQ ID NO: 16) | In silico modeling |
| 10 | FGSGVGSGH (SEQ ID NO: 17) | In silico modeling |
| 11 | WHVTFY (SEQ ID NO: 18) | In silico modeling |
| 12 | WHVTYF (SEQ ID NO: 19) | In silico modeling |
| 18 | HGGSVGGSF (SEQ ID NO: 20) | In silico modeling |

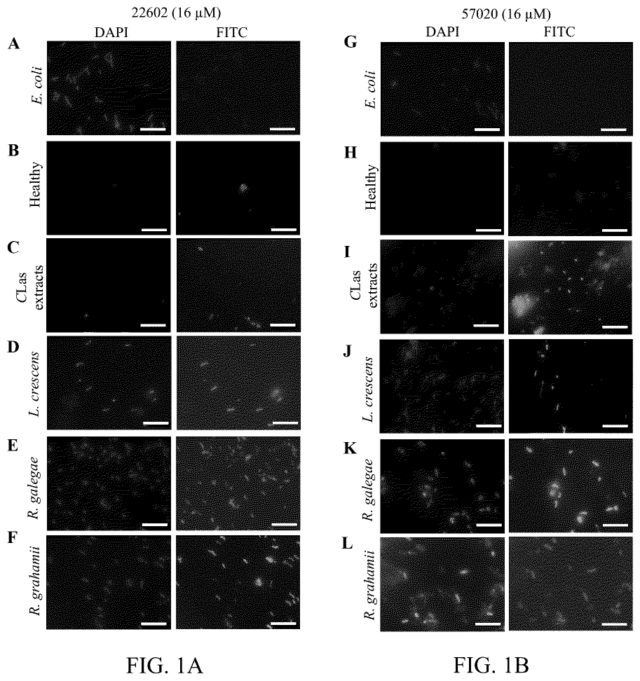

The about 13 CLas binding peptides and Pseudomonas mendocina binding KH peptides were synthesized with an N-terminal FITC label to assess their binding to CLas in plant extracts and three closely related semi-fastidious/culturable surrogate bacteria (L. crescens, Rhizobium galegae, R. grahamii) using fluorescence microscopy-based approaches. As per established methods, all the BamA binding peptides were synthesized by a contract service (LifeTein). The FITC-labeled peptides were dissolved in appropriate solvents and used for binding assays. From these assays, we were able to identify two predicted BamA binding peptides (BamA_22602 and BamA_50720, Table 1) that showed consistent binding to all four target bacteria (CLas, L. crescens, R. galegae, and R. grahamii) but not to an unrelated bacterium (Escherichia coli) (FIGS. 1A-1L). Efficacy testing against CLas in citrus trees is a laborious and time-consuming process and not practical for pre-screening several candidates. Alternative approaches to efficacy testing can be employed, which include using the ex vivo CLas-citrus hairy root system [9] and testing in culturable surrogates closely related to CLas (Liberibacter crescens, Rhizobium spp., and Sinorhizobium spp.) [5, 10].

STAMPs were further designed using two CLas binders (22602 and 50720) and a broad-spectrum antimicrobial peptide (SOD12) from spinach that possesses anti-CLas activity [9], using an inert linker amino acid sequence (GGSGGS) in both orientations (N- and C-terminal fusions) (Table 2). The mature AMP peptide without the leader sequence was utilized. The binders and the STAMPs were further synthesized and used for the efficacy trials. The AMP alone was also used to determine the baseline activity of the non-targeted AMPs. Because CLas is an unculturable bacterium, efficacy testing of the STAMPs was conducted by multiple approaches, which include cell viability assays using semi-fastidious/culturable surrogates (R. galegae and Liberibacter crescens), in vitro growth inhibition assays using a culturable surrogate (R. grahamii) and an ex vivo CLas-citrus hairy root assay.

TABLE 2
List of STAMPs (amino acid sequences) comprising Candidatus Liberibacter
spp. binders (22602 and 57020) and antimicrobial peptides (AMPs), SOD12
and SOD2* (Ref: Mirkov and Mandadi, US10640784B2). Note: A linker
peptide is shown in italics, and the AMP sequences were trimmed to
remove a predicted signal peptide.

| ID | Sequence |
|---|---|
| SOD12 | RICESASYRFKGICVSRSNCANVCKNEGFPGGRCRGFRRRCLCYKHCG |
| | (SEQ ID NO: 32) |
| 22602- | MGINGFKFLSDIHHFCSGGSGGSRICESASYRFKGICVSRSNCANVCKN |
| SOD12 | EGFPGGRCRGFRRRCLCYKHCG (SEQ ID NO: 21) |
| SOD12- | RICESASYRFKGICVSRSNCANVCKNEGFPGGRCRGFRRRCLCYKHCG |
| 22602 | GGSGGSMGINGFKFLSDIHHFCS (SEQ ID NO: 22) |
| 57020- | SRNSSIALGLRRAYAVFNYFVARGIGGSGGSRICESASYRFKGICVSRSN |
| SOD12 | CANVCKNEGFPGGRCRGFRRRCLCYKHCG (SEQ ID NO: 23) |
| SOD12- | RICESASYRFKGICVSRSNCANVCKNEGFPGGRCRGFRRRCLCYKHCG |
| 57020 | GGSGGSSRNSSIALGLRRAYAVFNYFVARGI (SEQ ID NO: 24) |
| SOD2* | GIFSSRKCKTPSKTFKGICTRDSNCDTSCRYEGYPAGDCKGIRRRCLCC |
| | THT (SEQ ID NO: 33) |
| 22602- | MGINGFKFLSDIHHFCSGGSGGSGIFSSRKCKTPSKTFKGICTRDSNCDT |
| SOD2* | SCRYEGYPAGDCKGIRRRCLCCTHT (SEQ ID NO: 25) |
| SOD2*- | GIFSSRKCKTPSKTFKGICTRDSNCDTSCRYEGYPAGDCKGIRRRCLCC |
| 22602 | THTGGSGGSMGINGFKFLSDIHHFCS (SEQ ID NO: 26) |
| 57020- | SRNSSIALGLRRAYAVFNYFVARGIGGSGGSGIFSSRKCKTPSKTFKGIC |
| SOD2* | TRDSNCDTSCRYEGYPAGDCKGIRRRCLCCTHT (SEQ ID NO: 27) |
| SOD2*- | GIFSSRKCKTPSKTFKGICTRDSNCDTSCRYEGYPAGDCKGIRRRCLCC |
| 57020 | THTGGSGGSSRNSSIALGLRRAYAVFNYFVARGI (SEQ ID NO: 28) |

TABLE 3
List of codon-optimized AMP and STAMP genetic sequences (open
reading frames). Start and Stop codons are in bold.

| ID | Sequence |
|---|---|
| SOD12 | ATGAGAATTTGCGAGTCTGCTTCATATAGGTTTAAGGGAATTTGTG |
| | TTTCTAGGTCTAATTGCGCTAACGTGTGCAAGAATGAGGGCTTT |
| | CCTGGTGGAAGATGCAGGGGTTTCAGGAGAAGGTGCCTTTGTTACA |
| | AGCATTGTGGCTAA (SEQ ID NO: 35) |
| 22602- | ATGGGTATTAATGGTTTTAAGTTCCTTTCAGATATTCATCACTTTTG |
| SOD12 | CTCTGGTGGTTCTGGTGGTTCTAGGATTTGCGAGTCTGCTTCA |
| | TATAGGTTCAAGGGAATTTGCGTTTCTAGGTCTAATTGCGCTAACGT |
| | GTGCAAGAATGAGGGCTTTCCTGGAGGCAGATGCAGGGGTTTC |
| | AGGAGAAGGTGCTTGTGTTACAAACATTGTGGCTAA (SEQ ID NO: |
| | 36) |
| SOD12- | ATGAGAATTTGCGAGTCTGCTTCATATAGGTTTAAGGGCATTTGTG |
| 22602 | TTTCTAGGTCTAATTGCGCTAACGTGTGCAAGAATGAGGGTTTT |
| | CCTGGTGGAAGATGCAGGGGATTCAGGAGAAGGTGCCTTTGTTACA |
| | AGCATTGTGGCGGTGGATCTGGCGGTTCAATGGGAATTAACGGC |
| | TTTAAATTCTTGTCTGATATTCATCACTTCTGCTCATAA (SEQ ID NO: |
| | 37) |
| 57020- | ATGTCAAGAAATAGCAGTATCGCTTTGGGGCTGAGAAGGGCTTATG |
| SOD12 | CTGTGTTCAATTACTTTGTTGCCAGGGGTATCGGCGGGTCGGGT |
| | GGATCTAGGATTTGCGAGTCTGCTTCATATAGGTTTAAGGGCATTT |
| | GTGTTTCTAGGTCAAATTGCGCTAACGTGTGCAAGAATGAGGGT |
| | TTCCCTGGGGGAAGATGTAGAGGTTTTAGGAGAAGATGCCTGTGTT |
| | ACAAGCACTGCGGATAA (SEQ ID NO: 38) |
| SOD12- | ATGAGGATTTGTGAGAGTGCCAGCTATAGATTCAAGGGGATTTGCG |
| 57020 | TGAGTAGGAGTAACTGTGCTAATGTTTGTAAGAACGAGGGTTTT |
| | CCTGGTGGAAGATGCAGGGGATTCAGGAGAAGGTGCCTTTGTTATA |
| | AGCATTGTGGCGGTGGATCTGGCGGTTCTTCAAGAAATTCTTCA |
| | ATTGCATTGGGGCTTAGGAGAGCATACGCCGTTTTCAACTACTTCG |
| | TGGCAAGAGGAATCTGA (SEQ ID NO: 39) |
| SOD2* | ATGGGTATTTTCTCTTCAAGAAAGTGCAAAACTCCTTCTAAGACTTT |
| | TAAGGGTATTTGTACTAGAGATTCAAACTGCGATACATCTTGTAGA |
| | TATGAGGGTTACCCAGCTGGAGATTGCAAAGGCATTAGGAGAAGG |
| | TGTTTGTGCTGTACTCATACATAA (SEQ ID NO: 40) |
| 22602- | ATGGGAATTAATGGCTTTAAGTTCCTTTCAGATATTCATCACTTCTG |
| SOD2* | CTCTGGTGGATCAGGCGGTTCTGGTATTTTCTCTTCAAGAAAG |
| | TGCAAAACTCCTTCTAAGACTTTTAAGGGTATTTGTACTAGAGATTC |
| | AAACTGCGATACATCTTGTAGATATGAGGGTTACCCAGCTGGA |
| | GATTGCAAAGGCATTAGGAGAAGGTGTTTGTGCTGTACTCATACAT |
| | AA (SEQ ID NO: 41) |
| SOD2*- | ATGGGTATTTTCTCTTCTAGGAAGTGCAAGACTCCTTCTAAGACATT |
| 22602 | CAAAGGTATTTGTACTAGAGATTCTAATTGCGATACATCATGT |
| | AGATATGAGGGTTACCCAGCTGGAGATTGCAAGGGCATTAGGAGA |
| | AGGTGTCTTTGCTGTACTCATACAGGTGGATCTGGCGGTTCAATG |
| | GGAATTAACGGCTTTAAATTCTTGTCTGATATTCATCACTTCTGCTC |
| | ATAA (SEQ ID NO: 42) |
| 57020- | ATGAGCAGAAACTCGTCTATCGCACTTGGACTTAGGAGAGCATACG |
| SOD2* | CTGTGTTCAATTACTTTGTGGCTAGGGGAATCGGGGGCAGTGGT |
| | GGATCTGGCATTTTCTCTTCAAGGAAGTGCAAAACTCCTTCAAAGA |
| | CATTCAAAGGTATTTGTACTAGGGATTCTAATTGCGATACATCA |
| | TGTAGATATGAGGGTTACCCCGCTGGCGATTGTAAAGGGATAAGAA |
| | GAAGATGCCTCTGTTGTACTCACACATAA (SEQ ID NO: 43) |
| SOD2*- | ATGGGTATCTTCTCTTCTAGGAAATGCAAAACACCATCAAAAACAT |
| 57020 | TCAAGGGTATCTGCACAAGGGACAGCAACTGCGACACATCTTGC |
| | AGATATGAGGGATACCCTGCTGGCGATTGCAAGGGTATTAGGAGA |
| | AGGTGTCTTTGCTGTACTCATACAGGTGGATCTGGCGGTTCTTCA |
| | AGGAATTCTTCAATTGCACTGGGGCTGAGAAGGGCTTATGCTGTTT |
| | TCAACTATTTTGTGGCAAGGGGAATCTGA (SEQ ID NO: 44) |

Viability/mortality assays were performed by treating L. crescens and R. galegae with various STAMPs, binders, and AMPs, alongside untreated and boiled cells as negative and positive controls. Live and dead cells were differentiated using a Viability/Cytotoxicity assay kit for bacteria (Biotium, Fremont, CA). The assay utilizes two fluorescent dyes to detect live and dead cells. DMAO is a membrane-permeable dye that stains both live and dead cells green. At the same time, the ethidium homodimer III (EthD-III) is a membrane-impermeable DNA dye that stains only dead cells red. Mortality rate (%) is estimated by counting the number of dead cells (red stained) among all cells (green stained).

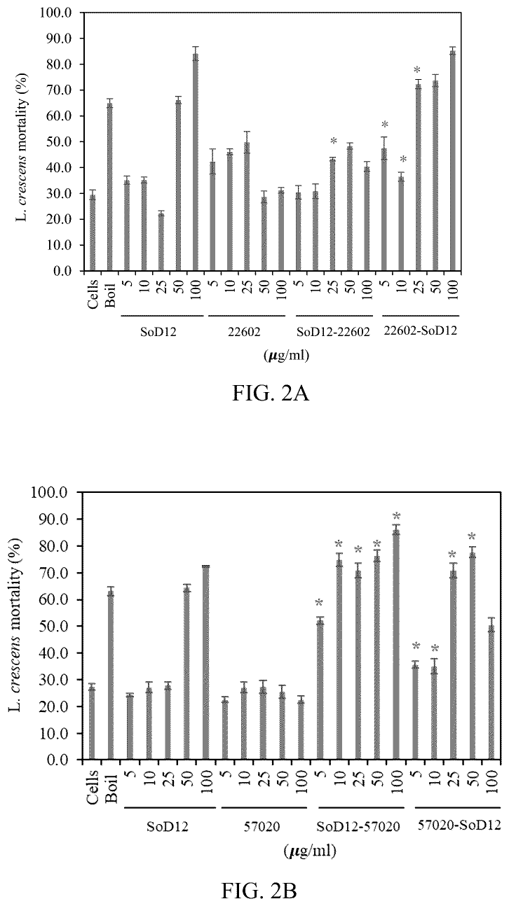

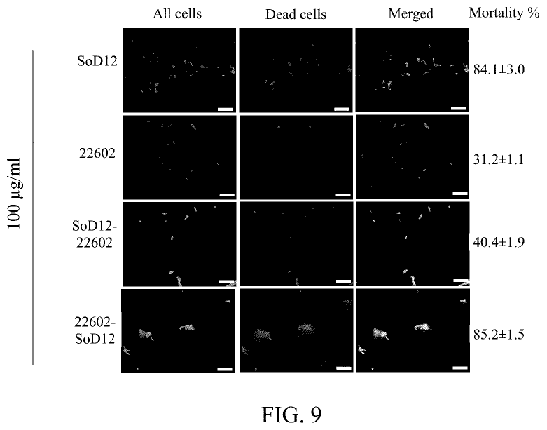

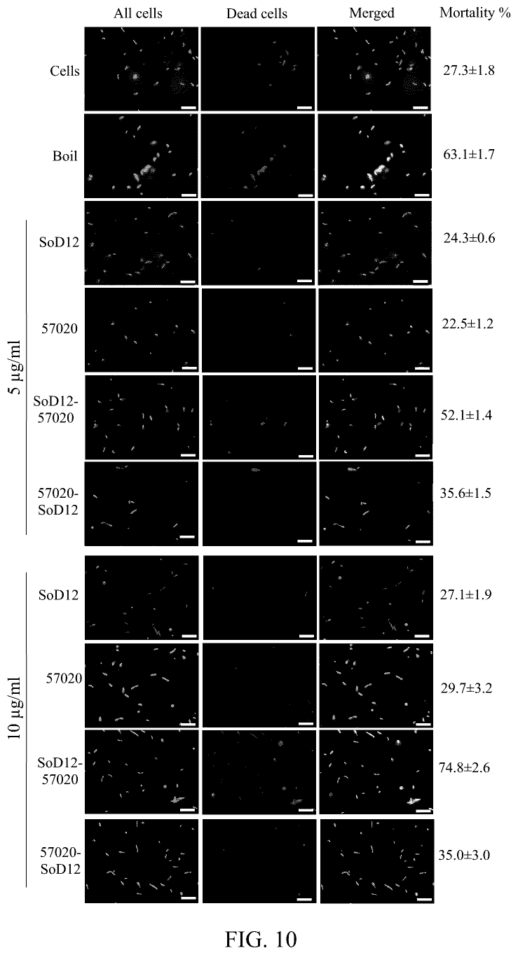

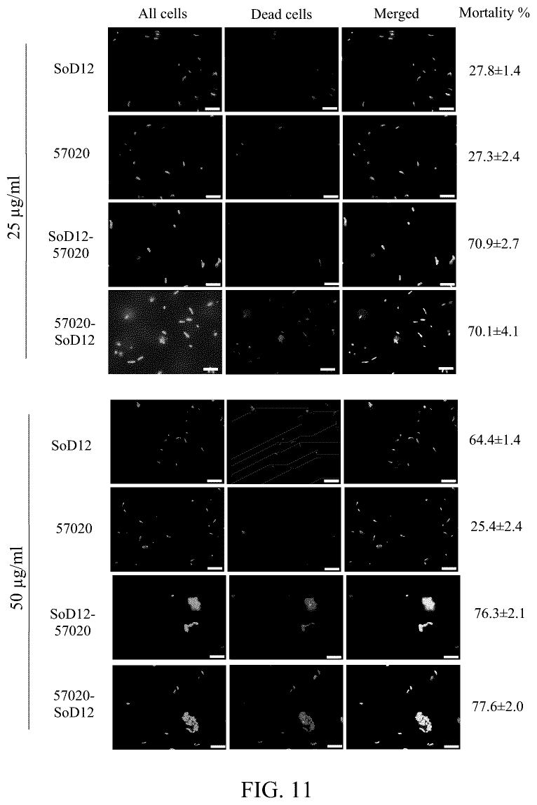

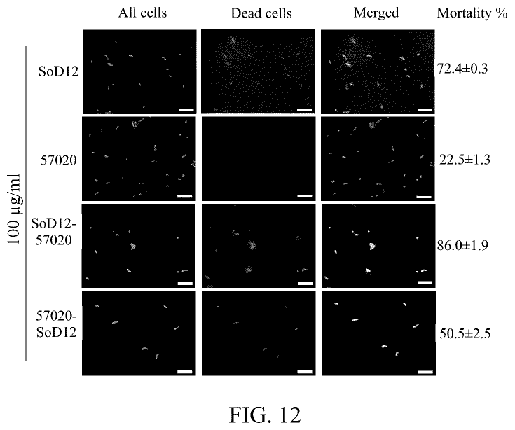

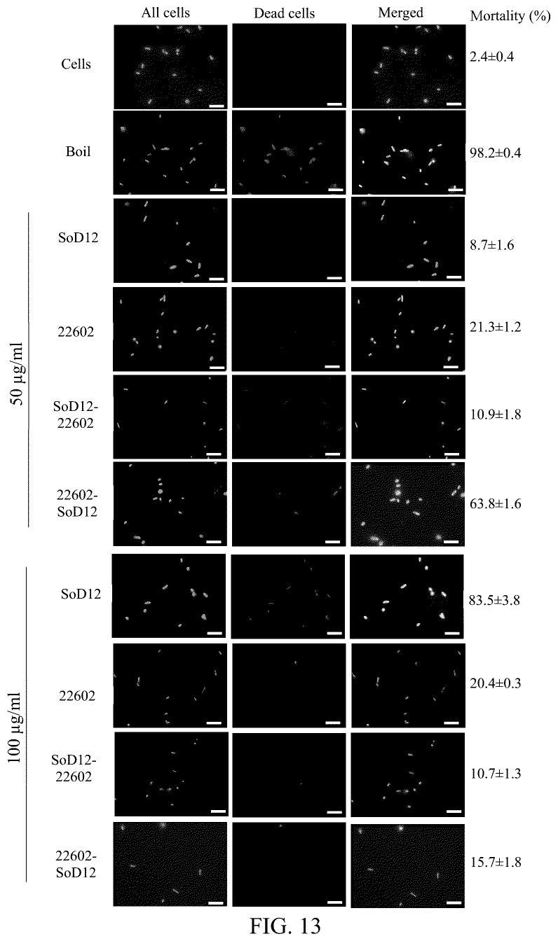

The basal mortality rate of untreated L. crescens cells was ˜25-30%, reflecting its somewhat semi-fastidious and selective growth requirements (FIGS. 2A-2B, FIGS. 7-12). The mortality rate of cells that were boiled was ˜65%. Mortality rates of SOD12-treated cells at 50 and 100 μg/ml dosages were ˜65-85%, thus confirming SOD12 antimicrobial activity against L. crescens (FIGS. 2A-2B, FIGS. 7-12). Lower dosage treatment of SOD12 at 5, 10, or 25 μg/ml was ineffective and comparable to the basal mortality of untreated cells (FIGS. 2A-2B, FIGS. 7-12). Regarding the STAMP treatments, the mortality rates were generally similar to SOD12 at 50 and 100 μg/ml dosage treatments (FIGS. 2A-2B, FIGS. 7-12). However, the differences between STAMPs and AMP alone were apparent at a lower dosage of 5, 10, or 25 μg/ml. All the tested STAMPs showed significantly (p≤0.05) higher (˜2 to 3-fold) efficacy than SOD12 at lower dosages (FIGS. 2A-2B, FIGS. 7-12).

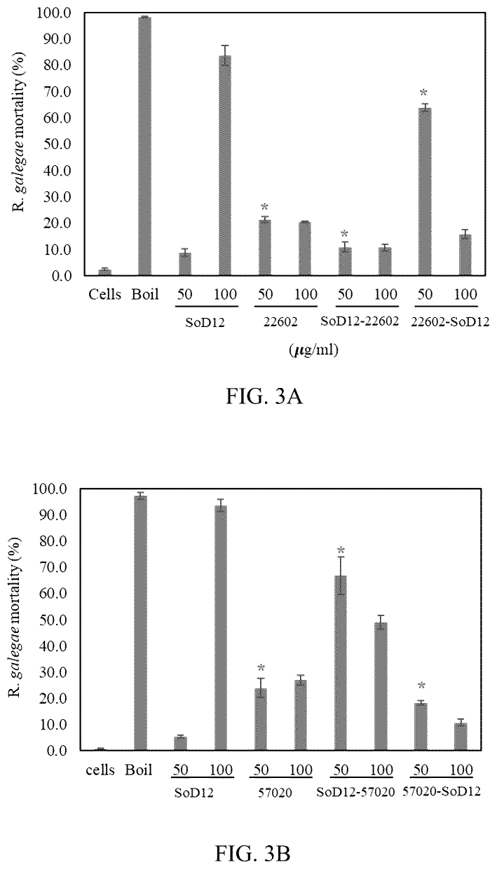

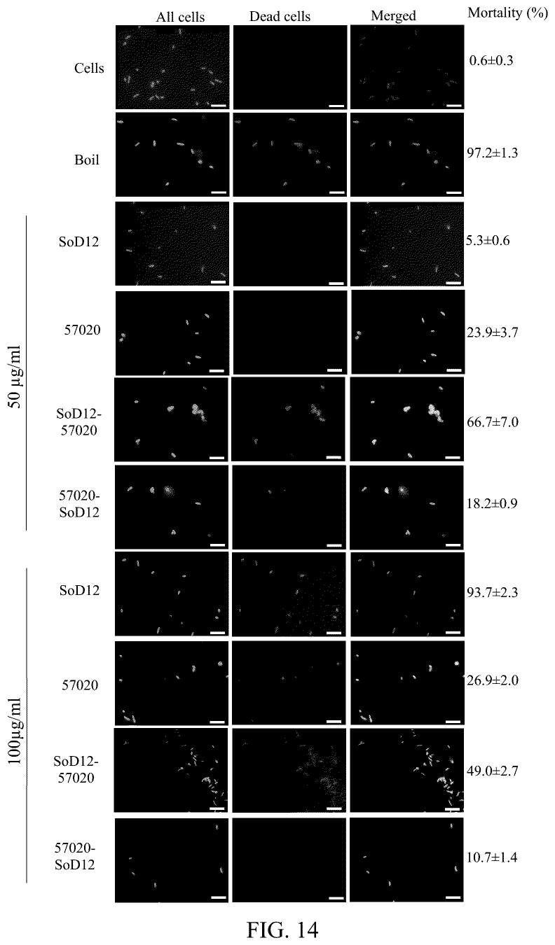

We also conducted efficacy assays with R. galegae. SOD12 treatments showed a dose-dependent inhibitory activity with 50 μg/ml resulting in ˜8% mortality, while a dosage of 100 μg/ml resulted in mortality rates of >80% (FIGS. 3A-3B, FIGS. 13-14). Among the STAMP treatments, 22602-SOD12 and SOD12-57020 both showed significantly greater (˜8- to 12-fold) efficacy than SOD12 alone at 50 μg/ml (FIGS. 3A-3B, FIGS. 13-14). Interestingly, the orientation of the binder, N- or C-terminus, appeared to impact efficacy in R. galegae. For instance, SOD12-22602 and 57020-SOD12 showed lower efficacy than those observed with 22602-SOD12 and SOD12-57020 (FIGS. 3A-3B, FIGS. 13-14). The results also showed that treatment with binders alone (57020 and 22602) at higher dosages (100 μg/ml) caused some mortality (20-27%) (FIGS. 3A-3B, FIGS. 13-14), suggesting that the binders could by themselves interfere with native CLas BamA function leading to cell mortality. However, the efficacy was lower than the STAMP treatments, underscoring the significance of the AMP. Lastly, we observed that higher dosage treatments at 100 μg/ml were not necessarily better than 50 μg/ml (FIGS. 3A-3B, FIGS. 13-14), suggesting a need for optimizing effective dosages of STAMPs empirically, depending on the target bacterium.

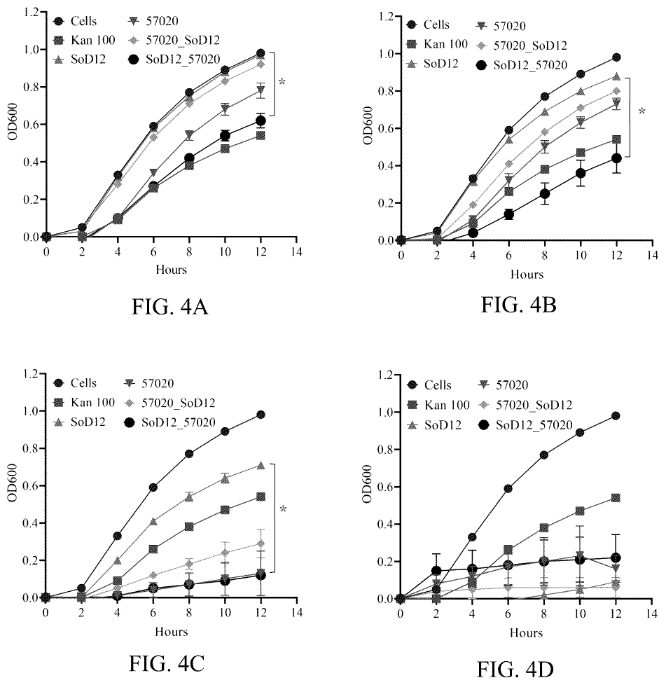

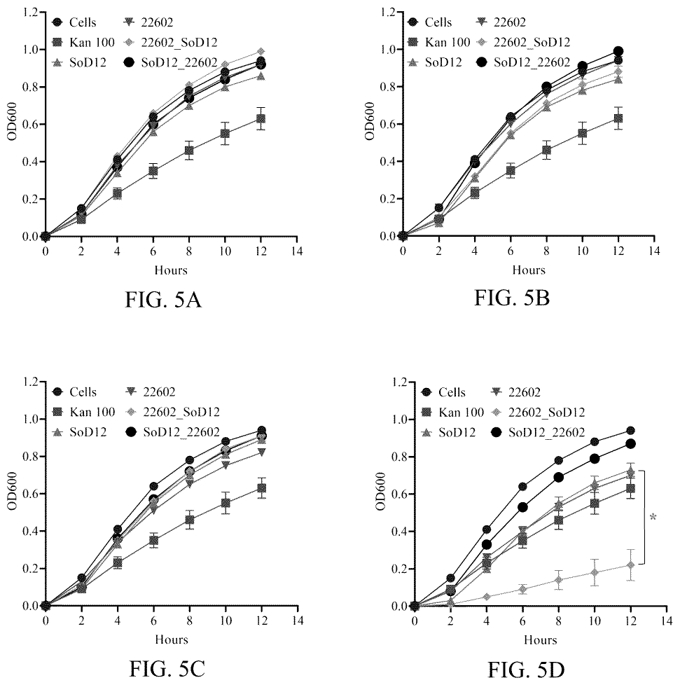

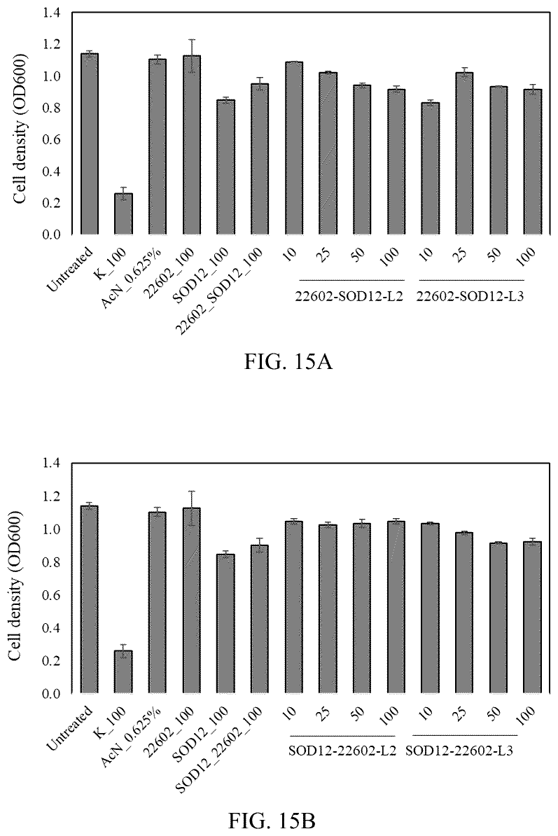

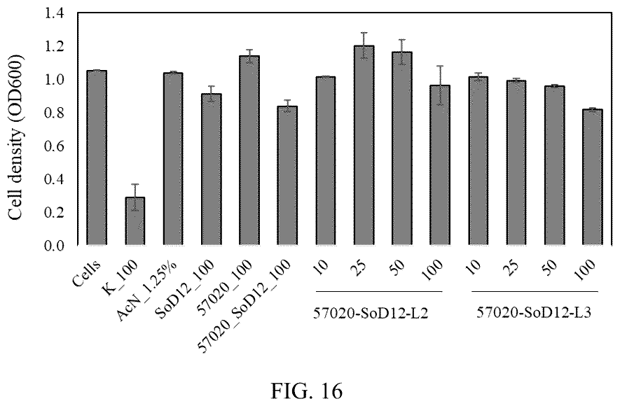

Efficacy assays were also performed using a third culturable surrogate, R. grahamii, by measuring in vitro growth inhibition rates. Briefly, R. grahamii cells were cultured in the presence of SOD12, binders (22602 and 57020), and the various STAMPs (22602-SoD12, SoD12-22602, SoD12-57020, 57020-SoD12) at different dosages (10, 25, 50, 100 μg/ml). Cell density measurements were recorded until untreated cells reached OD₆₀₀ of ˜1. Kanamycin (100 μg/ml) was used as an antibiotic control inhibitor. The results showed that both 57020 binder and its corresponding STAMPs (SOD12-57020 and 507020-SoD12) had significantly greater efficacy than SOD12 alone, especially at lower dosages (50 μg/ml) (FIGS. 4A-4D). Unlike against L. crescens and R. galegae, the effectiveness of 22602-based STAMPs did not show much activity (FIGS. 5A-5D). This suggests that there may be potential differences in the binding of 22602 STAMPs with the BamA ortholog of R. grahamii. We also evaluated whether the linker length could affect 22602-based STAMP efficacy. N- and C-terminus conjugated versions of 22602 and SOD12 were synthesized with 2× or 3× linker lengths (1×=GGSGGS), followed by in vitro growth inhibition assays in R. grahamii. The results showed that increasing the linker length (2× or 3×) did not improve the activity (FIG. 15A-15B) compared to the 1× linker. Similar results were obtained with an active STAMP, 507020-SOD12. Adding longer linkers (2× or 3×) did not enhance the activity of the 507020-SOD12 with a 1× linker (FIG. 16).

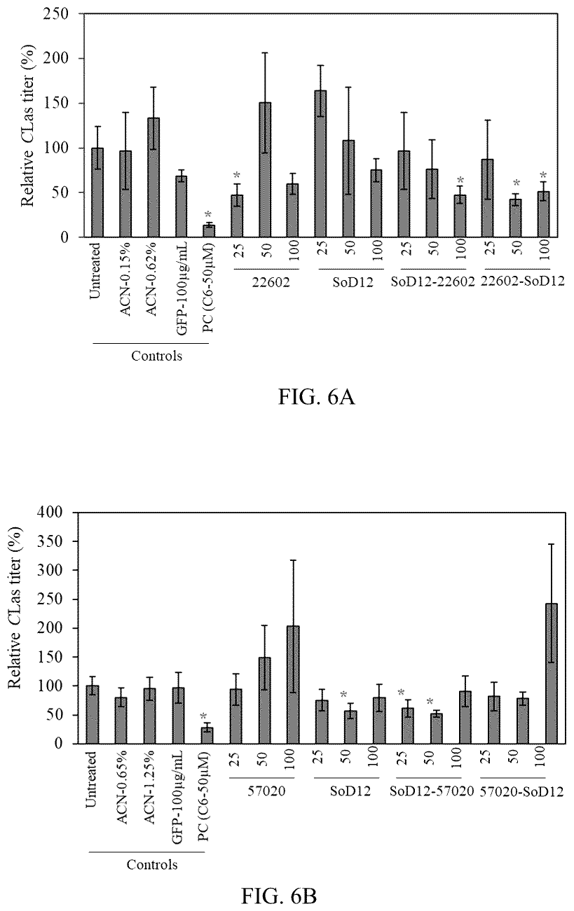

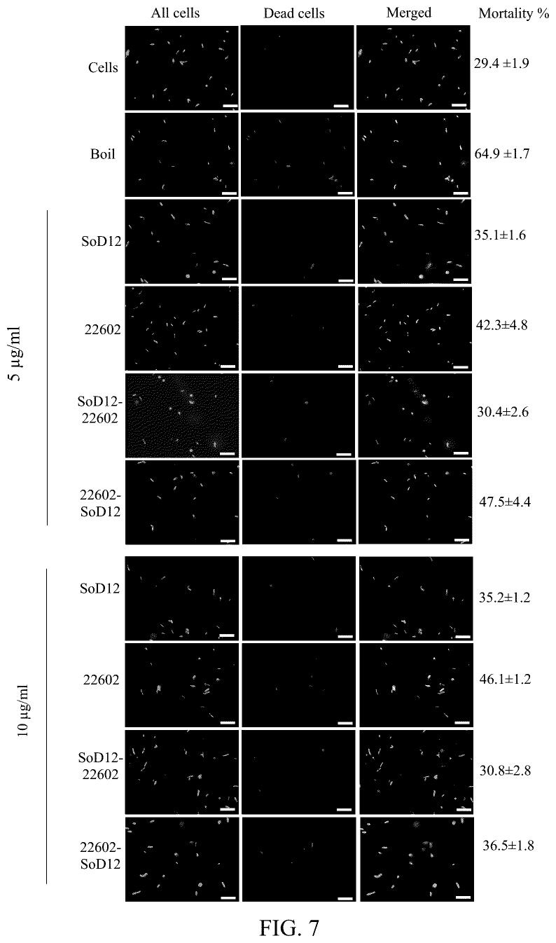

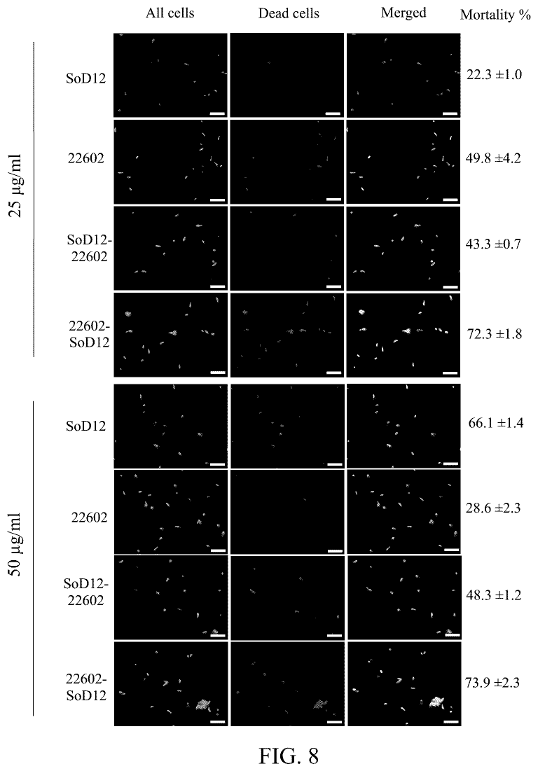

Next, the efficacy of the STAMPs was evaluated against the prime target bacterium, CLas. Because CLas is unculturable, we utilized a well-established CLas-citrus hairy root bioassay to determine STAMP efficacy [9]. In this assay, CLas is propagated in citrus hairy roots, and hairy roots were infiltrated with the different STAMPs and binders for 72 hours at different dosages (25, 50, and 100 μg/ml). Untreated, acetonitrile solvent (0.1, 0.6, or 1.2%) and GFP (100 μg/ml) were used as negative controls, while cinoxacin (50 μM) was used as a reference antibiotic. Subsequently, total DNA was isolated from the roots, and relative CLas titers were estimated using quantitative (q) PCR. The results showed that at dosages where SOD12 alone treatment was ineffective or moderately effective (25, 50, 100 μg/ml), the corresponding STAMP treatments showed significant anti-CLas activity (FIGS. 6A-6B).

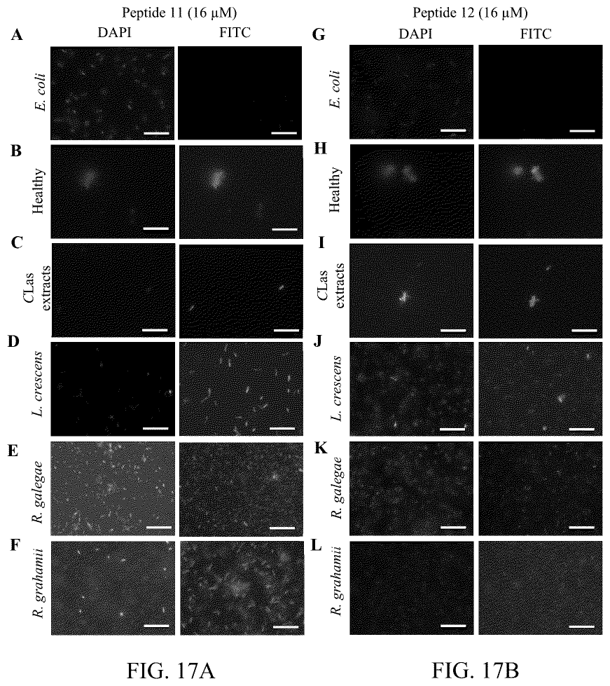

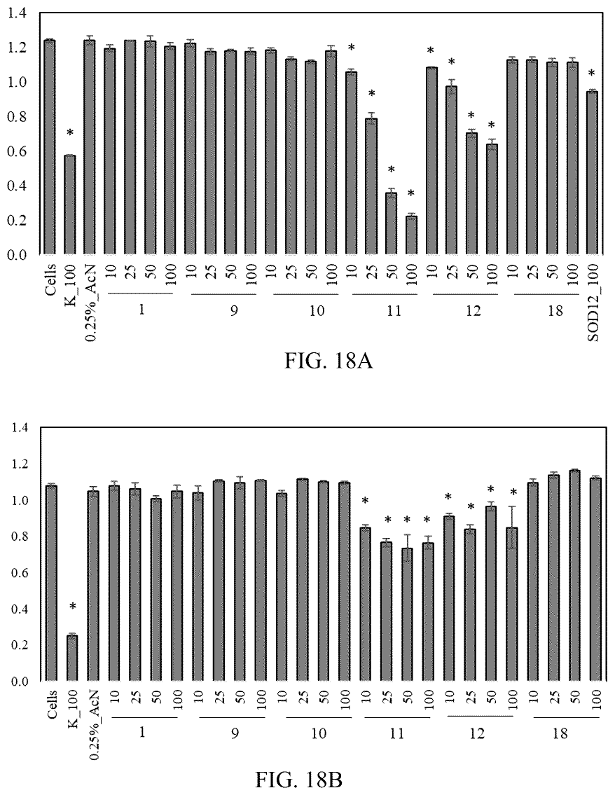

In conclusion, we designed and evaluated the efficacy of multiple novel C. Liberibacter binders and specifically targeted antimicrobial peptides (STAMPs). The efficacy testing assays using CLas-citrus hairy roots and multiple CLas surrogates showed that STAMPs had up to 12-fold enhanced efficacy than a non-targeted AMP. Additional evaluation of C. Liberibacter binders/STAMPs (Table 1, FIGS. 17A-17L, 18A-18B) are also included.

### EXAMPLE 2—HOMOLOGY MODEL OF BAMA

Out of the eleven homology models of BamA built using SWISS-MODEL, the most suitable model was selected based on GMQE and QMEAN. This model was based on the BAM complex of Escherichia coli (PDB ID: 5D0O) [23], and showed a GMQE value of 0.65 and QMEAN value of −3.03.

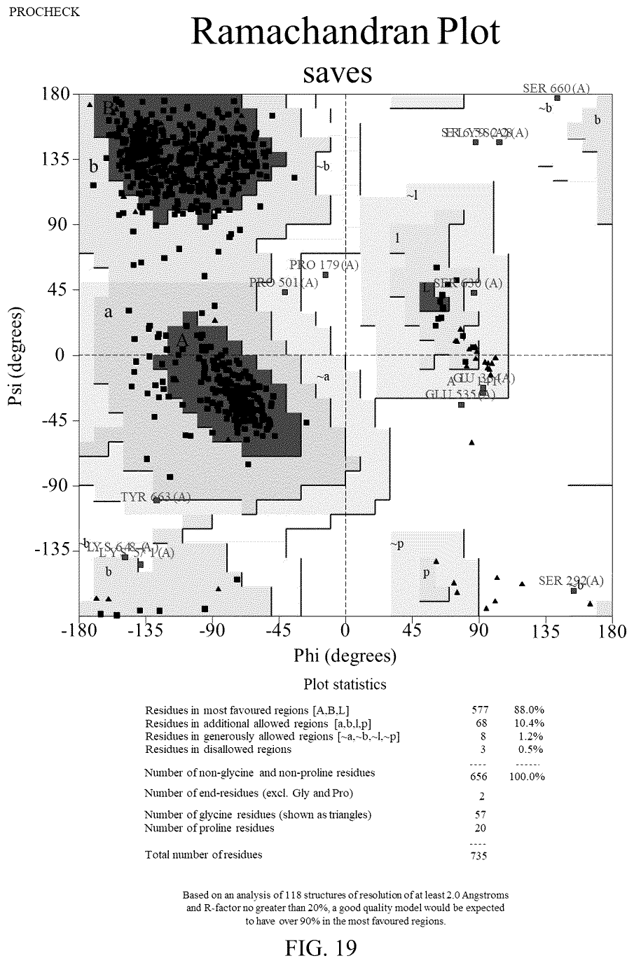

The selected model was validated by checking the Ramachandran plot (FIG. 19). According to the Ramachandran plot, 88% of the residues were in the most favored regions, and 10.4% were in additionally allowed regions. Since more than 98% of the residues are in favored regions, this can be considered as a reasonable structure [41]. The residues which were in disallowed regions are PRO179, SER659 and LYS228. However, none of these residues are located near the top part of the β-barrel, and thus unlikely to affect simulation results.

### EXAMPLE 3—SCREENING OF PEPTIDES WITH HIGH AFFINITY TOWARDS BAMA

Based on STRING database screening and protein-protein docking, three peptide sequences that interacted strongly with BamA were identified, which are given in Table 4.

TABLE 4
Peptide sequences that interacted strongly with BamA

| Protein | Peptide segment | Amino acid sequence |
|---|---|---|
| ACT56973.1 | 80-96 | QSFYYVSQKKKWFPVKF (SEQ ID NO: 29) |
| ACT56869.1 | 241-255 | DLHPQFQNLLKKSQN (SEQ ID NO: 30) |
| ACT57020.1 | 94-118 | SRNSSIALGLRRAYAVFNYFVARGI (SEQ |
| | | ID NO: 31) |

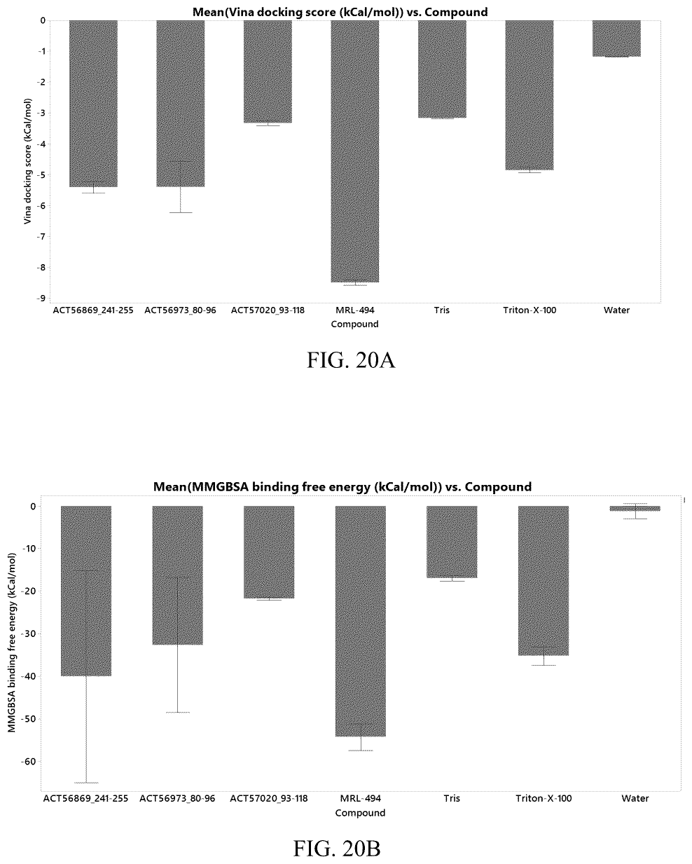

The affinity of these peptides was evaluated using AutoDock Vina docking scores and MM-GBSA free energies. MRL-494, which has been reported as an inhibitor of BamA protein in multiple Gram-negative bacterial strains [42], and Triton-X-100, which has been reported to have a strong affinity towards plant cell membranes [5], were used as positive controls, while water and Tris, which are reported to preserve the structural integrity of proteins [43], were used as negative controls. Docking scores and MM-GBSA free energies of the selected peptides are given in FIGS. 20A-20B.

From FIG. 20A it can be observed that the peptide segments ACT56973.1_80-96 and ACT56869.1_241-255 have shown the most negative vina docking scores among the HASPs, with an average docking score of −5.4 kcal/mol. Their docking scores are even more negative than Triton-X-100, although not as negative as MRL-494, which shows a highly negative average docking score of −8.5 kcal/mol. MM-GBSA free energies (FIG. 20B) also follow a similar pattern to vina docking scores. MRL-494 shows the most negative MM-GBSA energy (−54.3 kcal/mol). Among the three peptides, ACT56869.1_241-255 has the most negative free energy (−40.1 kcal/mol), while ACT56973.1_80-96 also shows a significantly negative binding free energy (−32.7 kcal/mol). An average docking score of −5.4 kcal/mol and significantly negative MM-GBSA binding energies suggest that the two peptides ACT56973.1_80-96 and ACT56869.1_241-255, bind quite strongly to the top of the barrel in BamA protein, which makes them promising candidates for BamA blockage. Compared to those two peptides, ACT57020.1_93-118 showed slightly weaker affinity, with docking score of −3.35 kcal/mol and MM-GBSA energy of −21.8 kcal/mol.

### EXAMPLE 4—BIO-LAYER INTERFEROMETRY OF SELECTED HASPS

The binding of the two selected HASPs to BamA was tested in-vitro using Bio-Layer Interferometry (BLI). BLI results for the HASPs and controls are given in Table 5.

TABLE 5
Rate of association (Kₐ), rate of dissociation
(k_{d}) and affinity constant (K_{D}) for HASPs and controls.
all data are presented as mean ± standard deviation.

| Compound | Kₐ (1/M · s) | K_{d} (1/s) | K_{D}(nM) | Avg R² |
|---|---|---|---|---|
| ACT56869.1_241-255 | 49610 ± | 0.01167 ± | 269.8 ± | 0.514 |
| | 20847 | 0.00323 | 128.5 | |
| ACT56973.1_80-96 | 852433 ± | 0.2111 ± | 247.5 ± | 0.925 |
| | 11909 | 0.0152 | 15.1 | |
| ACT57020.1_94-118 | 15857 ± | 0.0032 ± | 208.6 ± | 0.908 |
| | 4745 | 0.00056 | 53.7 | |
| MRL-494 | 17045 ± | 0.0813 ± | 6973 ± | 0.855 |
| | 17840 | 0.0472 | 3674 | |

According to the BLI results, all three peptides show strong binding to BamA, with affinity constants in the range of 200-300 nM. Out of those three, ACT57020.1_94-118 shows a slightly stronger affinity than the other two. ACT56973.1_80-96 shows the highest association rate, meaning that it has a high tendency to bind to BamA, but the high dissociation rate implies it does not bind very tightly. In comparison, ACT57020.1_94-118 shows lower association rate, but its very low dissociation rate implies very tight binding [44]. Therefore, the BLI results suggests that ACT57020.1_94-118 is the most promising HASP, since it can stay bound to BamA for longer periods of time. An unusual observation is that all three HASPs show higher affinity than the control MRL-494, which can be attributed to the smaller size of MRL-494 molecule, which makes it harder for BLI to detect it [45].

### EXAMPLE 5—MOLECULAR DOCKING AND FREE ENERGY CALCULATION FOR AMPS AND STAMPS

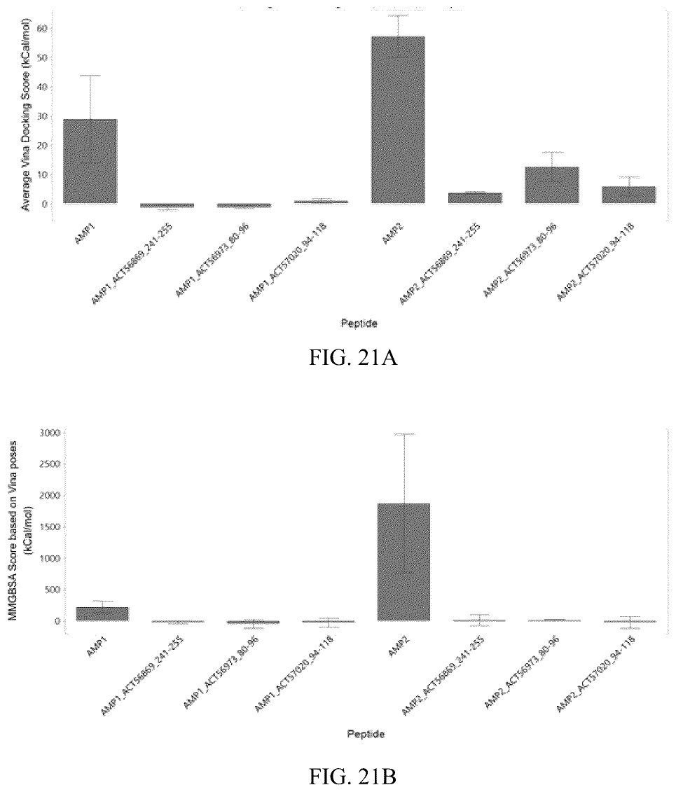

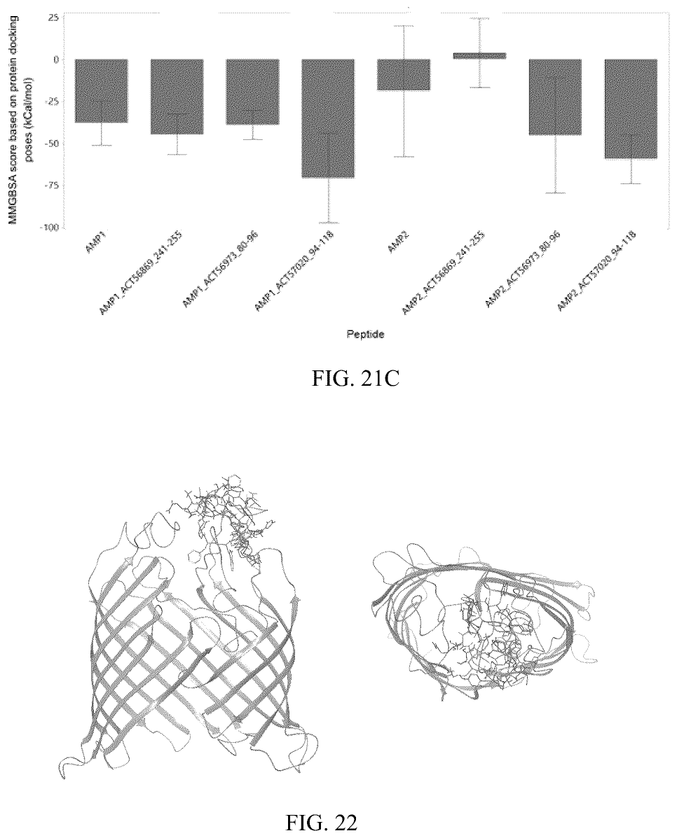

The goal of this study was to investigate the potential of creating specifically targeting antimicrobial peptides (STAMPs) by fusing the AMPs with HASPs. Two AMPs based on sequences that have already been proven to show antimicrobial properties were used for this. The effect of fusing the AMPs with HASPs was analyzed via Vina docking scores and MM-GBSA free energies for AMPs and STAMPs (FIGS. 21A-21C).

As shown in FIGS. 21A-21B, the docking scores and MM-GBSA binding free energies based on Vina poses are highly positive for both AMPs, suggesting that it is highly improbable that these AMPs bind to BamA protein. However, once fusing with HASPs, a significant change in binding affinity can be observed. According to vina results, the two composite STAMPs AMP1_ACT56869.1_241-255 and AMP1_ACT56973.1_80-96 both show slightly negative docking scores and MM-GBSA binding free energies towards BamA. This is promising since it suggests that fusing AMPs with HASPs can greatly improve the binding affinity of AMPs towards BamA, thus significantly increasing their chances for binding to BamA and assisting inhibition of the bacterial activity. Among those two STAMPs, AMP1_ACT56973.1_80-96 has shown the most negative docking score and MM-GBSA binding energy, which are around-1.5 kcal/mol and-45 kcal/mol, respectively. The docking scores and Vina-based MM-GBSA energies for the AMP2 based STAMPs are slightly positive, suggesting that these have a lower affinity towards BamA than AMPI based composites. This is explicable since AMP2 has an even weaker affinity towards BamA than AMP1.

However, it can be observed that the variability for MM-GBSA energies of AMPs and STAMPs based on vina poses are significant. The reason for this may be the low accuracy of AutoDock Vina poses for large peptides due to the presence of a high number of flexible bonds [46].

In order to minimize the impact due to limitations in AutoDock Vina, MM-GBSA scores were also evaluated based on the poses from Schrödinger protein-protein docking (FIG. 21C). These results are significantly different from the MM-GBSA energies based on vina poses, which may be due to the differences in docking algorithms and limitations of vina in peptide docking. Both AMPs have shown negative energies, with AMPI showing the more negative energy. However, even in these results, it can be observed that five of the STAMPs show more negative MM-GBSA binding energies (thus higher affinity) than the AMPs, with AMP1_ACT57020.1_94-118 showing the most negative MM-GBSA energy. The only exception is AMP2_ACT56869.1_241-255, which showed a positive MM-GBSA energy.

Considering all three parameters, it can be deduced that fusing the two selected AMPs with HASPs increases their affinity towards BamA. Among the six STAMPs, AMP1_ACT56869.1_241-255 and AMP1_ACT56973.1_80-96 have shown the best results, and thus were selected for the subsequent tests.

### EXAMPLE 6—ANALYSIS OF DOCKING POSES, INTERACTIONS AND MOLECULAR DYNAMICS

The binding of the HASPs to BamA protein was analyzed more thoroughly through visualization of binding poses and molecular dynamics. As observed in FIG. 22, both HASPs ACT56869.1_241-255 and ACT56973.1_80-96 bind tightly to the entrance of the β-barrel, suggesting the possibility of potential BamA inhibition by blocking cellular access. This was further supported by molecular dynamics simulations, which showed that the short peptides, especially ACT56869.1_241-255, stayed steady at the binding site during the simulation.

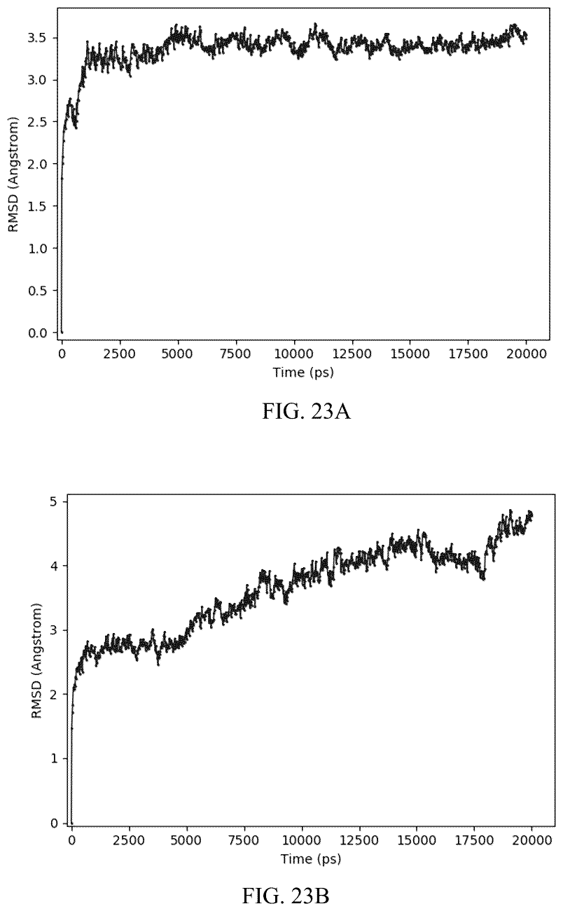

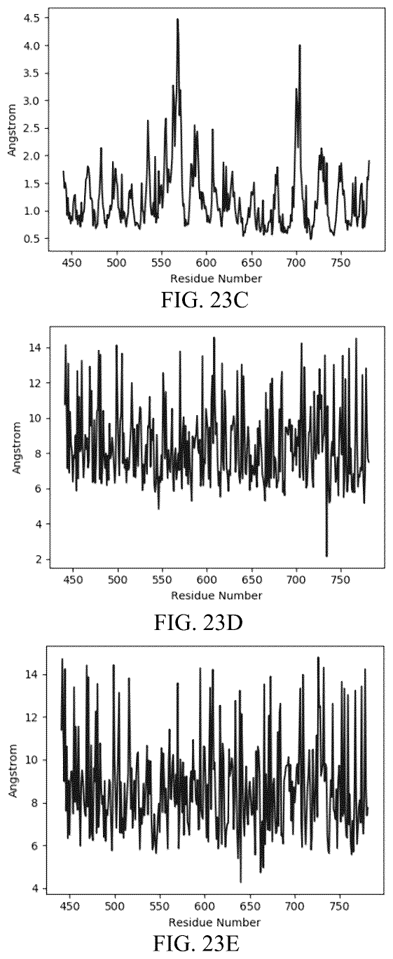

The stability of the simulations was evaluated through RMSD and RMSF plots (FIGS. 23A-23E). When ACT56869.1_241-255 is bound to BamA, the system stabilizes within 5 ns, at an RMSD around 3.5 Å. The mean RMSD for BamA_ACT56869.1_241-255 system is 3.362±0.227, which is only slightly different from the free protein. BamA complexed with ACT56973.1_80-96 shows somewhat higher fluctuation throughout the simulation, with a mean RMSD of 3.631±0.677. These RMSD values are in agreement with the reported RMSD range for peptide interactions [47]. RMSD plots also suggest that the peptide ACT56869.1_241-255 binds to the entrance of BamA in a very stable conformation, which can also be seen from the simulation trajectory.

RMSF plots show that, both BamA_ACT56869.1_241-255 and BamA_ACT56973.1_80-96 complexes show significantly higher RMSF values, compared to free BamA, suggesting that the flexibility of the protein has increased after binding of these peptides. Among the residues which are located in or close to the binding domain, the residues which have shown a highly significant increase in RMSF after peptide binding include ALA552, SER554, SER561, GLY673, ALA681, GLY683, GLY684, ASP728, GLY732 and GLY767. According to interaction analysis, only SER561, ASP728 and GLY767 among these residues showed strong interactions with the peptides, suggesting that the flexibility has mainly increased in residues not involved in strong interactions.

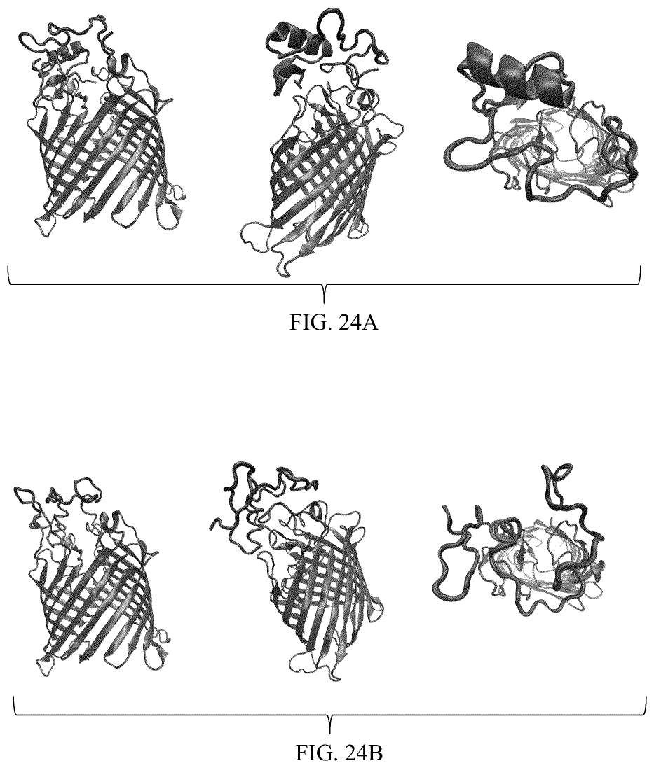

Since the two STAMPs AMP1_ACT56869.1_241-255 and AMP1_ACT56973.1_80-96 showed the most promising results in molecular docking and MM-GBSA energy analysis, the binding of these two STAMPs to BamA was visualized using VMD and is shown in FIGS. 24A-24B. As shown in FIGS. 24A-24B, the HASPs portions of both STAMPs have plugged into the top part of the β-barrel, effectively giving specific access for the AMPs to interact with the targets at close proximity to BamA in the cell membrane. The above approach can be a potential dual-action method to inhibit CLas by blocking BamA access and enhanced AMP action.

To identify which residues in BamA interacted most strongly with the peptides, an analysis was performed using ligand interaction analysis tool in Maestro. Three strongest binding poses were selected from each of the two docking tools (AutoDock Vina and Schrödinger protein-protein docking) and interactions that repeated on at least two configurations were identified. For positive controls, the docking poses were obtained from AutoDock Vina and Schrödinger Glide. The dominant interactions of cach compound with BamA is shown in Table 6.

TABLE 6
Residues in BamA which interacted with the chosen peptides and ligands on multiple
configurations

| | Main interactions with BamA | | |
|---|---|---|---|
| | | | Polar and |
| | | Hydrophobic | charged |
| Compound | H bonds | interactions | interactions |
| MRL-494 (control) | ARG675, | VAL676, | GLU557, |
| | ASP677, | ALA724, | ASP677, |
| | ASP728, | LEU730 | ASP768, |
| | GLU731, | | LYS769 |
| | ASP768 | | |
| ACT56869.1_241-255 | GLU557, | ILE559, | ASP677, |
| | TYR563, | ILE562, | LYS678 |
| | ARG675, | ALA724 | |
| | ASP677 | | |
| ACT56973.1_80-96 | ASP677, | | LYS556, |
| | LEU725, | | GLU557, |
| | GLY767, | | LYS558, |
| | ASP768 | | LYS729 |
| ACT57020.1_94-118 | ARG675, | | GLU555, |
| | ASP677, | | ASN647, |
| | LEU725 | | LYS648, |
| AMP1 (SOD2*) | GLU557, | ILE682, | GLU555, |
| GIFSSRKCKTPSKTFKGICTRDSNCDTS | LYS558, | ALA724, | LYS558, |
| CRYEGYPAGDCKGIRRRCLCCTHT | ASP677, | LEU725, | LYS678 |
| (SEQ ID NO: 33) | VAL723, | ALA727 | |
| | LEU725 | | |
| AMP2 (SOD12) | GLU555, | ILE559, | LYS556, |
| (RICESASYRFKGICVSRSNCANVCKN | ASP677, | VAL676, | GLU557, |
| EGFPGGRCRGFRRRCLCYKHCG) (SEQ | LEU725 | VAL723, | LYS558, |
| ID NO: 32) | | ALA724, | ASP677, |
| | | LEU725, | LYS678, |
| | | ALA727 | ASP728 |
| AMP1_ACT56869.1_241-255 | ASP677, | ILE562, | LYS556, |
| RKCKTPSKTFKGICTRDSNCDTSCRYE | VAL723, | TYR563, | LYS678 |
| GYPAGDCKGIRRRCLCCTHDLHPQFQ | ASP734 | LEU566 | |
| NLLKKSQN (SEQ ID NO: 58) | | | |
| AMP1_ACT56973.1_80-96 | GLU555, | VAL723, | LYS556, |
| RKCKTPSKTFKGICTRDSNCDTSCRYE | LYS558, | ALA724, | ARG675, |
| GYPAGDCKGIRRRCLCCTHQSFYYVS | ASP677, | LEU725, | ASP677, |
| QKKKWFPVKF (SEQ ID NO: 59) | ASP728, | ALA727 | LYS678, |
| | GLU766 | | LYS679 |
| AMP1_ACT57020.1_94-118 | GLU555, | VAL723, | GLU555, |
| RKCKTPSKTFKGICTRDSNCDTSCRYE | ASN721 | LEU725, | LYS556, |
| GYPAGDCKGIRRRCLCCTHSRNSSIAL | | LEU730 | GLU557, |
| GLRRAYAVFNYFVARGI (SEQ ID NO: | | | LYS558, |
| 60) | | | ASP677 |
| AMP2_ACT56869.1_241-255 | | VAL723, | LYS556, |
| RICESASYRFKGICVSRSNCANVCKNE | | ALA724, | LYS558 |
| GFPGGRCRGFRRRCLCYKHCDLHPQF | | LEU730 | |
| QNLLKKSQN (SEQ ID NO: 61) | | | |
| AMP2_ACT56973.1_80-96 | TYR563, | ILE562, | LYS558, |
| QSFYYVSQKKKWFPVKFRICESASYR | ARG675, | TYR563, | ASP677, |
| FKGICVSRSNCANVCKNEGFPGGRCR | GLU766 | ILE682, | LYS678, |
| GFRRRCLCYKHC (SEQ ID NO: 62) | | ALA724, | LYS679, |
| | | LEU725 | ASP728, |
| | | | ARG765, |
| | | | GLU766 |
| AMP2_ACT57020.1_94-118 | ASN721, | VAL723, | GLU555, |
| RICESASYRFKGICVSRSNCANVCKNE | GLY726, | ALA724, | ASN721, |
| GFPGGRCRGFRRRCLCYKHCSRNSSIA | ASP728, | LEU725 | ASP728, |
| LGLRRAYAVFNYFVARGI (SEQ ID NO: | ASP734, | | LYS729, |
| 63) | GLU766 | | ASN733, |
| | | | ASP734, |
| | | | GLU766 |

As shown in Table 6, most of the peptides and MRL-494 interacted with the same residues in BamA. ASP677 is a critical residue that formed hydrogen (H) bonds with all peptides except AMP2_ACT56869.1_241-255. It can be observed that there are several residues, especially ARG675, ASP677 and LEU725, which form H bonds with multiple HASPs and MRL-494, suggesting that the HASPs bind to the same region in BamA. Both AMPs also form H bonds with ASP677 and LEU725, and it can be observed that they engage in significantly more hydrophobic interactions than HASPs, which may be due to larger molecule size. The two STAMPs based on AMPI also form H bonds with the same residues which form H bonds with HASPs and AMPs. AMP2_ACT56973.1_80-96 makes H bonds with TYR563 and GLU766, which have not engaged in significant interactions with other peptides. However, the hydrophobic, polar and charged interactions of AMP2_ACT56973.1_80-96 with BamA are comparable to other peptides. The only STAMP which shows significantly different interactions is AMP2_ACT56869.1_241-255. It does not form any consistent H bonds with BamA, and also forms less hydrophobic, polar and charged interactions compared to other STAMPs. This agrees with the positive MM-GBSA score obtained for this peptide under both vina and protein-protein docking poses, suggesting that AMP2_ACT56973.1_80-96 is not very effective at binding to BamA. Overall, the interaction analysis also indicates that the AMP1_ACT56869.1_241-255 and AMP1_ACT56973.1_80-96 are the strongest binding STAMPs among the tested STAMPs, which is in agreement with docking results and MM-GBSA energy calculations.

Delivering drugs externally to CLas remains a challenge due to the phloem restricted nature of CLas. In-silico results show that fusing these AMPs with HASPs to make STAMPs increases the affinity of selected AMPs towards BamA, thus making it easier for AMPs to access their targets. This approach can inhibit CLas via the dual action of blocking BamA and improving the site specificity of AMPs.

### EXAMPLE 7—IN PLANTA EFFICACY TESTING OF AMP AND STAMPS IN CLAS-CITRUS COMPOSITE HAIRY ROOT PLANTS

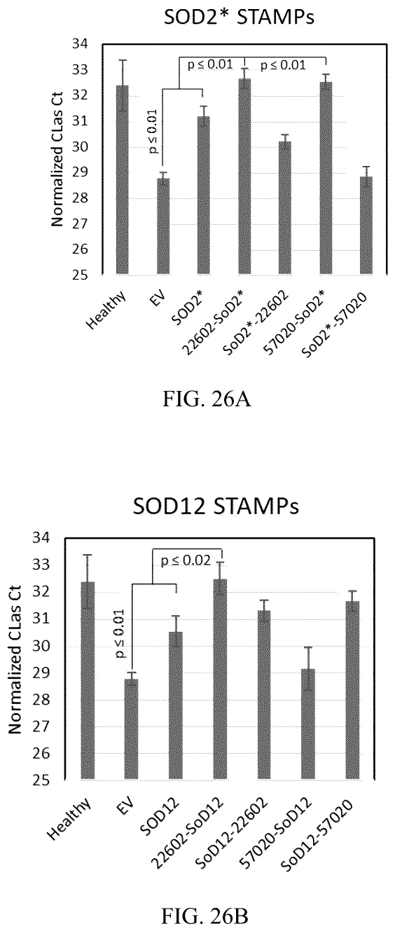

Three STAMPs showed improved efficacy compared to AMPs alone in CLas-citrus composite hairy root plants. CLas-citrus hairy root composite plants (4 months old) stably expressing AMPs (SOD2* and SOD12) and respective N- and C-terminus STAMPs (22602-SoD2*, SoD2*-22602, 57020-SoD2*, SoD2*-57020, 22602-SoD12, SoD12-22602, 57020-SoD12, SoD12-57020) in the roots were sampled. Relative CLas titers in the respective roots were estimated using quantitative (q) PCR. Healthy (non-infected) citrus and an empty vector (EV) transformed roots were used as controls. Compared to empty vector controls, roots expressing AMPs alone (SOD2* and SOD12) significantly lowered (p≤0.01) CLas titers (indicated by a higher CLas Ct value). Notably, three of the eight tested combinations of STAMPs (22602-SoD2*, 57020-SoD2*, and 22602-SoD12) showed an even greater reduction in CLas titers when compared to SOD2* or SOD12 alone, indicating improved efficacy using the STAMPs. Error bars represent ±standard error of the mean (n=3-5) (FIGS. 26A-26B).

It should be understood that the examples and embodiments described herein are for illustrative purposes only and that various modifications or changes in light thereof will be suggested to persons skilled in the art and are to be included within the spirit and purview of this application and the scope of the appended claims. In addition, any elements or limitations of any invention or embodiment thereof disclosed herein can be combined with any and/or all other elements or limitations (individually or in any combination) or any other invention or embodiment thereof disclosed herein, and all such combinations are contemplated within the scope of the invention without limitation thereto.

### REFERENCES

1. ADDIN EN.REFLIST Hodges A W, Spreen T H. Economic impacts of citrus greening (HLB) in Florida, 2006/07-2010/111. The Institute of Food and Agricultural Sciences (2012).

2. National Academies of Sciences E, Medicine. A review of the citrus greening research and development efforts supported by the Citrus Research and Development Foundation: Fighting a ravaging disease. National Academies Press (2018).

3. Zhang M, Guo Y, Powell C A, Doud M S, Yang C, Duan Y. Effective antibiotics against ‘Candidatus Liberibacter asiaticus’ in HLB-affected citrus plants identified via the graft-based evaluation. PLoS ONE 9, e111032 (2014).

4. Zhang M, et al. Field evaluation of integrated management for mitigating citrus Huanglongbing in Florida. Front Plant Sci 9, 1890 (2018).

5. Stover E, Stange R R, McCollum T G, Jaynes J, Irey M, Mirkov E. Screening antimicrobial peptides in vitro for use in developing transgenic citrus resistant to Huanglongbing and citrus canker. J Am Soc Hortic Sci 138, 142-148 (2013).

6. Li J, Trivedi P, Wang N. Field evaluation of plant defense inducers for the control of citrus huanglongbing. Phytopathology 106, 37-46 (2015).

7. Motghare M, Shukla P K, Kumar P, Sharma A K, Ghosh D K. Characterization of four vital protein encoding genes of Candidatus Liberibacter asiaticus the causal agent of citrus greening disease. Indian Phytopathology 71, 197-205 (2018).

8. Ha P T, et al. Host-free biofilm culture of “Candidatus Liberibacter asiaticus,” the bacterium associated with Huanglongbing. Biofilm 1, 100005 (2019).

9. Irigoyen S, et al. Plant hairy roots enable high throughput identification of antimicrobials against Candidatus Liberibacter spp. Nat Commun 11, 5802 (2020).

10. Barnett M J, Solow-Cordero D E, Long S R. A high-throughput system to identify inhibitors of Candidatus Liberibacter asiaticus transcription regulators. Proc Natl Acad Sci 116, 18009-18014 (2019).

11. Wilson D S, Keefe A D, Szostak J W. The use of mRNA display to select high-affinity protein-binding peptides. Proceedings of the National Academy of Sciences 98, 3750-3755 (2001).

12. Ding F, Duan Y, Paul C, Brlansky R H, Hartung J S. Localization and Distribution of ‘Candidatus Liberibacter asiaticus’ in Citrus and Periwinkle by Direct Tissue Blot Immuno Assay with an Anti-OmpA Polyclonal Antibody. PLoS One 10, e0123939 (2015).

13. Bové, J. M., HUANGLONGBING: A DESTRUCTIVE, NEWLY-EMERGING, CENTURY-OLD DISEASE OF CITRUS. Journal of Plant Pathology, 2006. 88 (1): p. 7-37.

14. Ramsey, J. S., et al., Metabolic Interplay between the Asian Citrus Psyllid and Its Profftella Symbiont: An Achilles' Heel of the Citrus Greening Insect Vector. PloS one, 2015. 10 (11): p. e0140826-e0140826.

15. Wang, N., et al., The Candidatus Liberibacter-Host Interface: Insights into Pathogenesis Mechanisms and Disease Control. Annu Rev Phytopathol, 2017. 55: p. 451-482.

16. Akula, N., et al., Identification of small molecule inhibitors against SecA of Candidatus Liberibacter asiaticus by structure based design. Eur J Med Chem, 2012. 54: p. 919-24.

17. Hajeri, S., et al., Citrus tristeza virus-based RNAi in citrus plants induces gene silencing in Diaphorina citri, a phloem-sap sucking insect vector of citrus greening disease (Huanglongbing). Journal of Biotechnology, 2014. 176: p. 42-49.

18. Hao, G., E. Stover, and G. Gupta, Overexpression of a Modified Plant Thionin Enhances Disease Resistance to Citrus Canker and Huanglongbing (HLB). Frontiers in Plant Science, 2016. 7 (1078).

19. Dutt, M., et al., Transgenic citrus expressing an Arabidopsis NPR1 gene exhibit enhanced resistance against Huanglongbing (HLB; Citrus Greening). PloS one, 2015. 10 (9).

20. Guerra-Lupián, M.-A., et al., Localized expression of antimicrobial proteins mitigates huanglongbing symptoms in Mexican lime. Journal of Biotechnology, 2018. 285: p. 74-83.

21. Han, L., et al., Structure of the BAM complex and its implications for biogenesis of outer-membrane proteins. Nat Struct Mol Biol, 2016. 23 (3): p. 192-6.

22. Browning, D. F., et al., Mutational and Topological Analysis of the Escherichia coli BamA Protein. PLoS ONE, 2013. 8 (12): p. e84512.

23. Gu, Y., et al., Structural basis of outer membrane protein insertion by the BAM complex. Nature, 2016. 531: p. 64.

24. Noinaj, N., et al., Structural insight into the biogenesis of beta-barrel membrane proteins. Nature, 2013. 501 (7467): p. 385-90.

25. Kim, K. H., S. Aulakh, and M. Paetzel, The bacterial outer membrane β-barrel assembly machinery. Protein Science, 2012. 21 (6): p. 751-768.

26. Inui Kishi, R. N., et al., Evaluation of cytotoxicity features of antimicrobial peptides with potential to control bacterial diseases of citrus. PLoS One, 2018. 13 (9): p. e0203451.

27. Patel, S. and N. Akhtar, Antimicrobial peptides (AMPs): The quintessential ‘offense and defense’ molecules are more than antimicrobials. Biomedicine & Pharmacotherapy, 2017. 95: p. 1276-1283.

28. Rajasekaran, K., J. M. Jaynes, and J. W. Cary, Transgenic Expression of Lytic Peptides in Food and Feed Crops to Control Phytopathogens and Preharvest Mycotoxin Contamination, in Mycotoxin Prevention and Control in Agriculture. 2009, American Chemical Society. p. 119-142.

29. Mirkov, T. E. and J. Gonzalez-Ramos, Pathogen resistant citrus compositions, organisms, systems, and methods. 2019, Google Patents.

30. Huang, C.-Y., et al., A stable antimicrobial peptide with dual functions of treating and preventing citrus Huanglongbing. Proceedings of the National Academy of Sciences, 2021. 118 (6): p. e2019628118.

31. Li, J., et al., The in Planta Effective Concentration of Oxytetracycline Against ‘Candidatus Liberibacter asiaticus’ for Suppression of Citrus Huanglongbing. Phytopathology®, 2019. 109 (12): p. 2046-2054.

32. Ding, F., et al., Serological detection of ‘Candidatus Liberibacter asiaticus’ in citrus, and identification by GeLC-MS/MS of a chaperone protein responding to cellular pathogens. Scientific Reports, 2016. 6 (1): p. 29272.

33. Altschul, S. F., et al., Basic local alignment search tool. J Mol Biol, 1990. 215 (3): p. 403-10.

34. Waterhouse, A., et al., SWISS-MODEL: homology modelling of protein structures and complexes. Nucleic Acids Res, 2018. 46 (W1): p. W296-w303.

35. Laskowski, R. A., et al., PROCHECK: a program to check the stereochemical quality of protein structures. Journal of Applied Crystallography, 1993. 26 (2): p. 283-291.

36. Kerenga, B. K., et al., Salt-Tolerant Antifungal and Antibacterial Activities of the Corn Defensin ZmD32. Frontiers in Microbiology, 2019. 10 (795).

37. Szklarczyk, D., et al., STRING v11: protein-protein association networks with increased coverage, supporting functional discovery in genome-wide experimental datasets. Nucleic acids research, 2019. 47 (D1): p. D607-D613.

38. Trott, O. and A. J. Olson, AutoDock Vina: improving the speed and accuracy of docking with a new scoring function, efficient optimization and multithreading. Journal of computational chemistry, 2010. 31 (2): p. 455-461.

39. Pettersen, E. F., et al., UCSF Chimera—a visualization system for exploratory research and analysis. J Comput Chem, 2004. 25 (13): p. 1605-12.

40. Humphrey, W., A. Dalke, and K. Schulten, VMD: visual molecular dynamics. Journal of molecular graphics, 1996. 14 (1): p. 33-38.

41. Elsliger, M. A. and I. A. Wilson, 1.8 Structure Validation and Analysis, in Comprehensive Biophysics, E. H. Egelman, Editor. 2012, Elsevier: Amsterdam. p. 116-135.

42. Hart, E. M., et al., A small-molecule inhibitor of BamA impervious to efflux and the outer membrane permeability barrier. Proceedings of the National Academy of Sciences, 2019. 116 (43): p. 21748-21757.

43. Muinao, T., M. Pal, and H. P. D. Boruah, Cytosolic and Transmembrane Protein Extraction Methods of Breast and Ovarian Cancer Cells: A Comparative Study. J Biomol Tech, 2018. 29 (3): p. 71-78.

44. Fang, Y., 2.17—Label-Free Screening Technologies, in Comprehensive Medicinal Chemistry III, S. Chackalamannil, D. Rotella, and S. E. Ward, Editors. 2017, Elsevier: Oxford. p. 416-433.

45. Peltomaa, R., et al., Optical biosensors for label-free detection of small molecules. Sensors, 2018. 18 (12): p. 4126.

46. Rentzsch, R. and B. Y. Renard, Docking small peptides remains a great challenge: an assessment using AutoDock Vina. Briefings in Bioinformatics, 2015. 16 (6): p. 1045-1056.

47. Dagliyan, O., et al., Structural and dynamic determinants of protein-peptide recognition. Structure (London, England: 1993), 2011. 19 (12): p. 1837-1845.

We claim:

1. A peptide comprising a protein binding sequence, wherein the protein binding sequence binds to a surface protein on a cell of a plant pathogen.

2. The peptide of claim 1, wherein the plant pathogen is a Candidatus Liberibacter sp.

3. The peptide of claim 2, wherein the Candidatus Liberibacter sp. is Candidatus Liberibacter asiaticus, Candidatus Liberibacter africanus, or Candidatus Liberibacter americanus.

4. The peptide of claim 1, further comprising an antimicrobial peptide sequence.

5. The peptide of claim 4, wherein the antimicrobial peptide sequence is SOD12, according to SEQ ID NO: 32; SOD2*, according to SEQ ID NO: 33; SOD8, according to SEQ ID NO: 45; SOD9, according to SEQ ID NO: 46; SOD10, according to SEQ ID NO: 47; SOD11, according to SEQ ID NO: 48; SOD13, according to SEQ ID NO: 49; AGM176, according to SEQ ID NO: 50; AGM179, according to SEQ ID NO: 51; MaSAM, according to SEQ ID NO: 52; Plantaricin JLA-9, according to SEQ ID NO: 53; Darobactin, according to SEQ ID NO: 54; Urechistachykinin II, according to SEQ ID NO: 55, or a homolog thereof.

6. The peptide of claim 4, further comprising a linker sequence.

7. The peptide of claim 6, wherein the linker sequence is GGSGGS (SEQ ID NO: 34. or a homolog thereof.

8. The peptide of claim 1, wherein the protein binding sequence is BamA_27401 according to SEQ ID NO: 2; BamA_22602, according to SEQ ID NO: 3; BamA_02401, according to SEQ ID NO: 4; BamA_01403 according to SEQ ID NO: 5; BamA_10701, according to SEQ ID NO: 6; BamA_03001, according to SEQ ID NO: 7; BamA_03501, according to SEQ ID NO: 8; BamA_46301, according to SEQ ID NO: 9; BamA_00901, according to SEQ ID NO: 10; BamA_00902, according to SEQ ID NO: 11; BamA_56973, according to SEQ ID NO: 12; BamA_56869, according to SEQ ID NO: 13; BamA_57020, according to SEQ ID NO: 14; peptide 1, according to SEQ ID NO: 15; peptide 9, according to SEQ ID NO: 16; peptide 10, according to SEQ ID NO: 17; peptide 11, according to SEQ ID NO: 18; peptide 12, according to SEQ ID NO: 19; peptide 18, according to SEQ ID NO: 20; ACT56973.1, according to SEQ ID NO: 29; ACT56869.1, according to SEQ ID NO: 30; ACT57020.1, according to SEQ ID NO: 31, or a homolog thereof.

9. The peptide of claim 4, where the peptide is 22602-SOD12, according to SEQ ID NO: 21; SOD12-22602, according to SEQ ID NO: 22; 57020-SOD12, according to SEQ ID NO: 23; SOD12-57020, according to SEQ ID NO: 24; 22602-SOD2*, according to SEQ ID NO: 25; SOD2*-22602, according to SEQ ID NO: 26; 57020-SOD2*, according to SEQ ID NO: 27; SOD2*-57020, according to SEQ ID NO: 28; AMP1_ACT56869.1_241-255, according to SEQ ID NO: 58; AMP1_ACT56973.1_80-96, according to SEQ ID NO: 59; AMP1_ACT57020.1_94-118, according to SEQ ID NO: 60; AMP2_ACT56869.1_241-255, according to SEQ ID NO: 61; AMP2_ACT56973.1_80-96, according to SEQ ID NO: 62; AMP2_ACT57020.1_94-118, according to SEQ ID NO: 63; or a homolog thereof.

10. The peptide of claim 1, wherein the protein binding sequence binds to a BamA protein on the surface of the plant pathogen cell.

11. A composition comprising the peptide of claim 1 and an agriculturally acceptable carrier.

12. The composition of claim 11, further comprising an agriculturally acceptable solvent.

13. The composition of claim 12, wherein the agriculturally acceptable solvent is acetonitrile.

14. The composition of claim 11, wherein the agriculturally acceptable carrier is water.

15. The composition of claim 11, wherein the peptide is at a concentration of about 5 μg/ml to about 500 μg/ml.

16. A method of controlling and/or treating a plant pathogen infection in a plant comprising applying the peptide of claim 1 to the plant or an environment around the plant.

17. The method of claim 16, wherein the composition is applied as a foliar spray, injection into the phloem, trunk feeding, or via irrigation.

18. The method of claim 16, wherein the plant is an orange tree, a lemon tree, a lime tree, a grapefruit tree, a clementine tree, a tangerine tree, a tangelo tree, a pomelo tree, or a potato plant.

19. The method of claim 16, wherein the plant pathogen is a Candidatus Liberibacter sp.

20. The method of claim 19, wherein the Candidatus Liberibacter sp. is Candidatus Liberibacter asiaticus, Candidatus Liberibacter africanus, or Candidatus Liberibacter americanus.
